(19) United States
(12) Patent Application Publication
(10) Pub. No.: US 2011/0298376 A1
(43) Pub. Date: Dec. 8, 2011

(54) Apparatus And Method For Producing Plasma

(75) Inventors: Masatomo Kanegae, Tokyo (JP); Kyoichi Kato, Ibaraki (JP); Kaoru Onoe, Chiba (JP); Daisuke Fukuoka, Chiba (JP)

(73) Assignee: RIVER BELL CO., Tokyo (JP)

(21) Appl. No.: 13/143,311

(22) PCT Filed: Jan. 12, 2010
(86) PCT No.: PCT/JP2010/050218

§ 371 Date: Aug. 26, 2011

(30) Foreign Application Priority Data
Jan. 13, 2009 (JP) 2009-004593

(51) Int. Cl. H05H 1/30

(52) U.S. Cl. 315/111.51

(57) ABSTRACT

The plasma generation device comp rising first plasma generation chamber 10 which has gas feed opening 12 and plasma exit 13, and first plasma generation means 11 which is arranged in space of said first plasma generation chamber in state of not exposed, and second plasma generation chamber 20 which has plasma feed opening 22 whereby plasma generated said first plasma generation chamber through said plasma exit, and second plasma generation means 21 which is arranged in space of said second plasma generation chamber in state of not exposed wherever generating higher density than plasma generated by said first plasma generation chamber.

### BACKGROUND OF THE INVENTION

Plasma is the electrically neutral state where the charged particles (typically positive ion and electron) are moving freely. Various applications are carrying out by using many active excitation molecules (radical) and ion in plasma.

For example, it is used for, coating, etching, doping, washing, etc., in the fields such as semiconductor and display device production, and is used for the chemistry and synthesis of chemical compound, polymerization of high polymer, analysis of a sample, etc. in the chemical field.

In these fields, the plasma generated by RF electric discharge in a vacuum is commonly used. However, since such method of discharging in a vacuum needed a vacuum pumping system, pressure retaining parts, a vacuum chamber, etc., furnishing became large-scale and the size of the object to be processed was restricted by the size of the chamber. Moreover, since carrying out pumping the chamber took time for each object to be processed, plasma processing was complicated and taking time to be improved.

Generating plasma for plasma processing under normal pressure to meet this demand is also studied.

Patent documents 1 shows a plasma reactor device consists of a cylindrical plasma torch which forms the pipe in a plasma torch to which the plasma gas lead-in pipe was connected inside of the plasma torch outer pipe outside a plasma torch by which the sample gas introduction pipe was connected.

An apical part of the high-melting conductor in the inner plasma torch is applied RF heating by supplying RF power to the RF coil, then high voltage impressed to this high-melting conductor through an igniter results stable inductively coupled plasma (ICP) under normal temperature and normal pressure condition with RF power supplied through the RF coil.

Moreover, a coaxial form microwave plasma torch consists of a cylindrical discharge tube with gas lead in pipe, a coaxial cable for microwave transmission and built-in antenna connected to inner conductor of the coaxial cable in the discharge tube is shown in patent documents 2.

While the microwave plasma torch of the patent documents 2 introduces gas in the discharge tube through a gas lead-in pipe from a gas source in normal pressure, microwave generated by microwave oscillator is transmitted through the coaxial cable and supplied with coaxial connector that results maximum electric field and causes microwave electric discharge between tip of the antenna and inner wall of the discharge tube, then microwave discharge plasma will generate.

Furthermore, patent documents 3 shows a device which emits plasma generated by dielectric barrier electric discharge by impressing RF high voltage to a discharge space between electrodes with dielectric material adhered in surface or adjusted and ground electrode in normal pressure.

A system which emits such a jet like plasma to space is called a plasma jet, and various systems are developed especially detailed plasma jet (micro plasma jet) of several millimeter or less in diameter.

Although the RF high voltage is impressed to the electrode in the patent document 3, micro plasma jet is generated under normal pressure by impressing low frequency high voltage electric power between electrodes estranged in co-axial form in external wall of a silica tube in non-patent document 1.

### PRIOR TECHNICAL DOCUMENTS

### Patent Documents

[PATENT DOCUMENT 1] Publication information: 2006-104545 (20.4.2006)
[PATENT DOCUMENT 2] Publication information: 2005-293955 (20.10.2005)
[PATENT DOCUMENT 3] Filed information: JP. 2589599 (5.12.1996)

### Non Patent Document

[NON PATENT DOCUMENT 1] Publication information: “Generation and analysis of an Advanced reaction field using submerged glow plasma” Katsuhisa Kitano

### SUMMARY OF THE INVENTION

### Problem to be Solved

Inductively-coupled-plasma generation means and microwave plasma generation means provide plasma generation system with high electric power, for various gases and offers high reactivity through high density plasma.

However, plasma generation under normal pressure is difficult in general compared with under vacuum case, and special ignition apparatus such as high-melting conductor in the patent document 1 or antenna in the patent document 2 are required to generate inductively coupled plasma and microwave plasma in normal pressure.

(Refer to XX of the Patent Document 1, YY of the Patent Document 2)

Although some report show plasma generation without ignition apparatus for rare gas such as helium gas (He) or argon gas (Ar) with low dielectric breakdown voltage, there is no means to generate plasma without ignition apparatus for other type of gas but rare gas.

As the plasma generation means with the ignition apparatus exposes this apparatus in plasma generation space, materials of the apparatus inevitably contaminates plasma.

As those materials of high-melting conductor or antenna cause metallic contamination or interfusion of impurity, plasma generator of this type cannot apply to the semiconductor or the display device production or chemical industry area which requires high purity circumstance.

Although plasma can be generated comparatively easily without ignition apparatus as micro plasma jet by impressing the high voltage to a regional domain using dielectric barrier electric discharge, plasma gas material is restricted to low dielectric breakdown one such as helium (He) gas or argon (Ar) gas.

Moreover, a micro plasma jet is classified with a low-temperature plasma of non-thermal stability with high electron temperature and low gas (ion) temperature, plasma density and reactivity is low compared with ICP or micro wave plasma.

Moreover, the plasma size itself was not suitable for use in the field of semiconductor manufacture which requires plasma processing to target object of large area.

An objective of this patent is offering the plasma generation device or the plasma generation method which generates stable and high density plasma without ignition apparatus such as a high-melting conductor or an antenna in normal pressure, or offering the plasma generation device or the plasma generation method which generates high clean and high purity plasma.

The other objectives of this patent are offering the plasma generation device or the plasma generation method which generates plasma with smaller power dissipation or with variety of gases or in sustainable stable and consecutive condition or in various conditions and fields.

### Method to Solve Problems

This patent of the plasma generation device is characterized to perform above problems which consists of first plasma generation chamber with a gas feed opening and a plasma exit, first plasma generation mean which is arranged without exposure in the first chamber space, a second plasma generation chamber with a plasma entry which lead in plasma output from the exit of the first plasma generation chamber and a second plasma generation means which is arranged without exposure in the second chamber space.

In this plasma generation device, the first plasma generation means may provide a pair of electrodes and provide insulation means which prevents electric discharge between this pair of electrodes outside of the first plasma generation chamber and this is desirable that the distance between said pair of electrodes is within 2 mm or more but 10 mm or less.

In the plasma generation device of mentioned above, said first plasma generation means may generate the first plasma by impressing AC high voltage to a single electrode.

In the plasma generation device of mentioned above, a bias electrode may be provided at the rear of the second plasma generation chamber, and the first plasma generation chamber may be located at the rear of the second plasma generation chamber.

In the plasma generation device of mentioned above, the distance from the first plasma generation means to the second plasma generation means should be longer than the plasma length which is generated by the second plasma chamber.

Furthermore, the first plasma generation chamber mounted on a part of piping and the second plasma generation chamber may be a plasma torch connected to this piping.

In this case, the distance from the second plasma generation means to a tip of the plasma torch should be within 5 mm or more but 15 mm or less.

Furthermore, the first plasma generation chamber may be laid as a part of contiguous strait piping and the second plasma generation chamber also be laid as another part of the piping. It is desirable the distance from the second plasma generation means to the tip of the piping is within 5 mm or more but 15 mm or less.

Furthermore, in the plasma generation device mentioned above, the second plasma generation means should provide coil which generates inductive coupled plasma in the second plasma generation chamber.

Furthermore, in the plasma generation mentioned above, should generate plasma in the second plasma generation chamber by generating plasma in the first plasma generation chamber using the first plasma generation means in normal pressure, higher than normal pressure or low vacuum state of 1.333×10⁴ Pa to 1.013×10⁵ Pa environment, then generate plasma in the second plasma generation chamber using both the second plasma generation means and the plasma previously generated by the first plasma generation chamber.

Furthermore, in the plasma generation device mentioned above, said second plasma generation chamber should be provided gas feed opening which leads gas without intervention of said first plasma generation chamber, and be consisted of the provided gas flows spirally in shape alongside the chamber side.

Furthermore, a liquid phase may be provided at the lower flow side of said the second plasma generation chamber.

The plasma generation method of this invention is characterized as generating the first plasma by supplying the first plasma gas to the first plasma generation chamber and supplying the electric power from the first plasma generation means which is located without exposure to the first plasma generation chamber space, then generating the second plasma by supplying the second plasma gas to the second plasma generation chamber and supplying the electric power from the second plasma generation means which is located without exposure to the second plasma generation chamber space and supplying the plasma generated by said first plasma generation chamber.

Furthermore, the plasma density of said second plasma may be higher than the plasma density of said the first plasma in above mentioned plasma generation method.

Also, said first plasma may be low temperature plasma and said second plasma may be high temperature plasma in above mentioned plasma generation method.

Furthermore, said second plasma should not be generated until said first plasma is supplied in above mentioned plasma generation method.

Furthermore, the supply of said first plasma gas or the supply electric power to said first plasma generation means may be stopped after the plasma generation started in said second generation chamber in above mentioned plasma generation method.

Furthermore, it is desirable that said second plasma generation means supplies electric power to said the second plasma generation chamber before said first plasma generation means supplies electric power to said first plasma generation chamber in above mentioned plasma generation method.

Furthermore, said first plasma may be supplied to said second plasma generation chamber from downstream side or said the first plasma or said second plasma may be extended to downstream side using a bias electrode provided to downstream side of said second plasma generation chamber in above mentioned plasma generation method.

Furthermore, it is desirable that said first plasma gas is rare gas such as helium gas, argon gas, xenon gas or neon gas, and said second plasma gas is mono type or mixture of rare gas such as helium gas, argon gas, xenon gas or neon gas, or halogen gas such as chlorofluorocarbon, hydrofluorocarbon, perfluorocarbon, CF₄, or C₂F₆, or gas for semiconductor manufacture use such as SiH₄, B₂H₆ or PH₃, or clean air, dry air, oxygen, nitrogen gas, hydrogen, vapor water, halogen, ozone, or SF₆ in above mentioned plasma generation method.

Furthermore, a part of said first plasma gas may be used as said second plasma gas in above mentioned plasma generation method.

Said second plasma gas may be led into said second plasma generation chamber without intervenient of said first plasma generation chamber in above mentioned plasma generation method.

In this case, said first plasma generation means may generate inductive coupled plasma of said the first plasma gas using coil and supplied electric power, and it is desirable that said second plasma gas is led into said second plasma generation chamber alongside in spiral shape in above mentioned plasma generation method.

Furthermore, it is desirable said second plasma generation means generates inductive coupled plasma of said second plasma gas using coil and supplied electric power in above mentioned plasma generation method.

Furthermore, it is desirable said first plasma and said second plasma are generated in normal pressure, higher than normal pressure, or rough vacuum state of 1.333×10⁴ Pa-1.013×10⁵ Pa environment in above mentioned plasma generation method.

Furthermore, said second plasma may be injected into liquid phase in above mentioned plasma generation method.

### Effect of Invention

The plasma generation device and the generation method of this invention generates a plasma (hereinafter called the first plasma) by impressing electric power from the first plasma generation means to the first plasma gas supplied through the gas feed opening in the first plasma generation chamber, then enable to supply relevant plasma to the second plasma generation chamber through plasma exit opening.

The second plasma generation chamber where a plasma (hereinafter called the second plasma) can be generated with smaller power dissipation by the second plasma gas supplied from plasma feed opening or the other entry and electric power supplied from the second plasma generation means and using the first plasma generated in the first plasma generation chamber through plasma exit and plasma feed opening.

For example, even under the condition of the electric power supplied from the second plasma generation means is insufficient to generate plasma, the second plasma can be generated in the second plasma generation chamber by using the first plasma supplied.

As the first plasma generation means and the second plasma generation means are not exposed to the first plasma generation chamber and the second plasma generation chamber respectively nor provided ignition apparatuses of high-melting metal in the chamber, very highly pure plasma can be generated by generation device and the generation method of this invention.

Hence low temperature plasma can be generated in the first plasma generation chamber relatively easily by using dielectric barrier discharge plasma for the first plasma generated by the first plasma generation means, power dissipation can be reduced.

Though low temperature plasma is narrow and low reactivity in itself, this invention utilizes this low temperature plasma as ignition means and generates high density high temperature plasma such as inductively coupled plasma as the second plasma in the second plasma generation chamber in normal pressure, and provides expansibility to the plasma processing of high reactivity high density high temperature plasma.

Furthermore, as the first plasma can be expanded in one direction as plasma jet by the first plasma generation means using a pair of electrodes, distance to the second plasma generation means can be longer then monopole electrode one, then the second plasma can be stabilized in shape.

In addition, the distance between the pair of electrodes can be narrowed by using an insulating means to prevent electric discharge between electrodes outside of the first plasma generation chamber, and power dissipation of the first plasma generation can be reduced.

Although inductively coupled plasma can be generated under normal pressure without ignition apparatus by the first plasma generation means using coil as the first plasma, its condition is highly restricted such as types of plasma gas, helium gas or argon gas, but it is possible to relax restriction for the second plasma gas in the second plasma generation chamber and various types of plasma can be generated include high discharge break voltage one.

The second plasma generated in the second plasma generation chamber can be higher density plasma than the first plasma, or the plasma which is not generated by the first plasma generation means under normal condition.

Especially, the second plasma generation means with coil can generate inductively coupled plasma of more than about 10¹⁵ cm⁻³ high electron density plasma compared to about 10¹¹⁻¹² cm⁻³ electron density of dielectric barrier discharge one under normal pressure.

Though the first plasma generation in the first plasma generation chamber is necessary at least in initial ignition stage for the second plasma generation in the second plasma generation chamber, the power supply to the first plasma generation means can cut off and stop the first plasma gas supply and the first plasma generation in the first plasma generation chamber after the second plasma generation is started and power dissipation can be reduced.

As mentioned above, the first plasma generated in the first plasma generation chamber is acted as ignition means of the second plasma generation in the second generation chamber and the plasma can be generated with smaller power dissipation in the plasma generation device and the generation method of this invention.

By mechanism of the plasma generation device and the generation method of this invention, it enables to use the second plasma generation chamber under normal pressure or high pressure condition where the plasma was difficult to generate without exposed ignition apparatus in the plasma generation chamber.

Furthermore, it is desirable to use the plasma generation device and the generation method of this invention under rough vacuum state of 1.333×10⁴ Pa-1.013×10⁵ Pa where the plasma is difficult to generate without ignition means.

As the plasma generation device and the generation method of this invention can generate high density plasma under normal pressure, it enables to apply plasma processing for vapor phase, liquid phase and solid phase, and supply pure plasma which can be applied for vast application area.

For example, it is applied for coat formation, etching, doping and washing etc. in fields such as a semiconductor industry and a display device production, or can be used for the reaction of a compound, composition, polymerization of a macromolecule, analysis of a sample, etc. in a chemical field.

In addition, processing of the metal, resin, plastics, etc. in the material processing field, resin, a plastic, etc. in surface modification field, and incinerated ashes, CFC chemicals, organic solvent and disposable or poorly soluble organic compound in processing field, sterilization, washing, deodorization and a cell culture in medical and bioscience field is expectable.

The details of these effects and other effects are indicated in the form of the following enforcement.

### BRIEF DESCRIPTION OF THE DRAWINGS

FIG. 1: The outline configuration of the plasma device of the present invention

FIG. 2(A)-(D) are configuration diagram illustrating an embodiment of the first plasma generation chamber and the first plasma generation means.

FIG. 3(A)-(C) are a configuration diagram illustrating an embodiment of the second plasma generation chamber and the second plasma generation means.

FIG. 4: The configuration diagram illustrating an embodiment of the plasma processing device of the present invention.

FIGS. 5(A) and (B) are configuration diagrams illustrating another embodiment of the plasma processing device of the present invention.

FIG. 6: The configuration diagram illustrating yet another embodiment of the plasma processing device of the present invention.

FIG. 7: Graph which shows the result from the embodiment 1.

FIG. 8: Graph which shows the result from the embodiment 1.

FIG. 9: Graph which shows the result from the embodiment 2.

FIG. 10: Graph which shows the result from the embodiment 2.

FIG. 11: Graph which shows the result from the embodiment 3.

FIG. 12: Graph which shows the result from the embodiment 3.

FIG. 13: Graph which shows the result from the comparative example 1.

FIG. 14: Graph which shows the result from the embodiment 2 and 3.

FIG. 15: The configuration diagram illustrating yet another embodiment of the plasma processing device of the present invention.

FIG. 16: The configuration diagram illustrating yet another embodiment of the plasma processing device of the present invention.

FIG. 17: The configuration diagram illustrating yet another embodiment of the plasma processing device of the present invention.

### DETAILED DESCRIPTION OF THE INVENTION

### Embodiments of the Invention

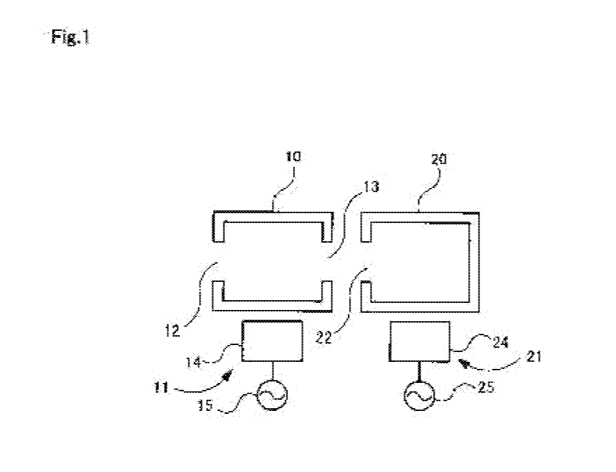

Hereafter, although the illustrative embodiment of the present invention is explained with drawings, the present invention is not limited to the following example. FIG. 1 is an outline configuration of the plasma device of the present invention.

The plasma device shown in FIG. 1 consists of the first plasma generation chamber 10, the first plasma generation means 11, the second plasma generation chamber 20, and the second plasma generation means 21 at least.

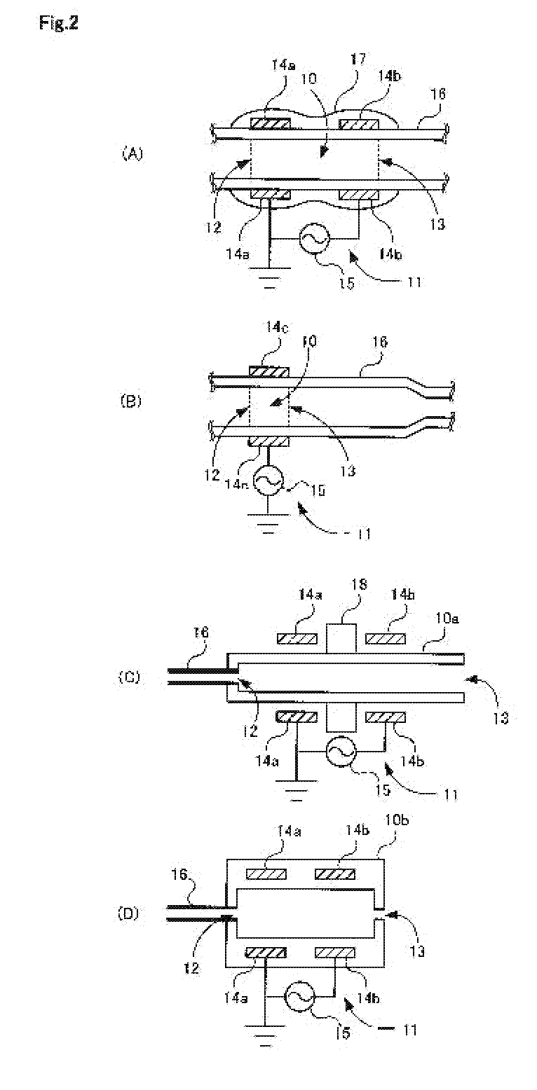

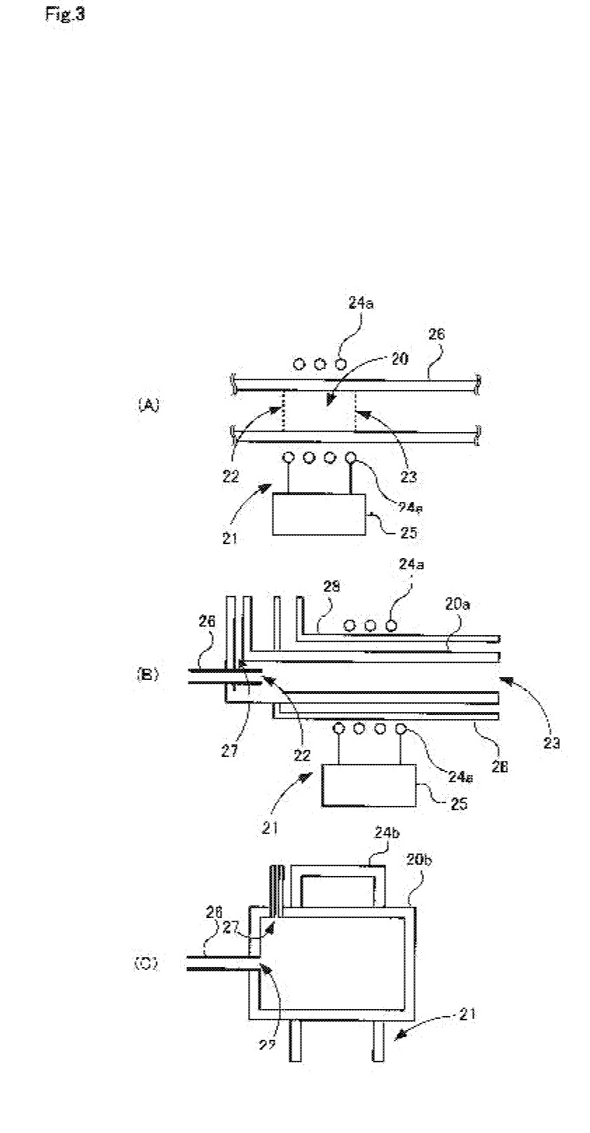

FIG. 2 is a configuration diagram illustrating an embodiment of the first plasma generation chamber 10 and the first plasma generation means 11, and FIG. 3 is a configuration diagram illustrating an embodiment of the second plasma generation chamber 20 and the second plasma generation means 21.

The first plasma generation chamber 10 has a gas feed opening 12 and a plasma exit 13, and includes the plasma generation space where plasma is generated by the first plasma generation means 11.

The first plasma generation chamber may be a part of piping which circulates plasma gas as illustrated to FIGS. 2 (A) and (B), or independently prepared a plasma generation chamber as illustrated to FIGS. 2 (C) and (D).

It is desirable to use a part of piping as first plasma generation chamber 10 since the present invention is realized with simple device composition.

FIGS. 2 (A) and (B) are the configurations which used piping 16 as first plasma generation chamber 10, and the piping 16 of downstream of a plasma exit is thinner one inside in case (B).

The first plasma can be extended longer by using the thin piping tip as shown in FIG. 2 (B).

When using a part of piping 16 as first plasma generation chamber 10, the portion where the first plasma generation means 11 is arranged is regarded as the plasma generation chamber.

For example, in FIG. 2 (A), the domain between the dotted lines from the end of one electrode 14a to the end of the electrode 14b is regarded as the first plasma generation chamber 10, and in FIG. 2 (B), the domain between the dotted lines between electrodes 14 is regarded as the first plasma generation chamber 10.

In addition, although the first plasma generation chamber 10 is established in the straight line portion of the same diameter of the piping 16 in FIGS. 2 (A) and (B), the piping may change in diameter size in the first plasma generation chamber 10, and may not be a straight line.

For example, the piping between a pair of electrodes 14a of FIG. 2 (A) may be prepared constricted part where the diameter becomes, and may not be straight, or the first plasma generation chamber 10 itself may be in curve shape, or may be bent in midway.

However, the looser angle is desirable for bent case.

The plasma torch 10a connected with piping 16 is used as first plasma generation chamber 10 in FIG. 2 (C), and polygon, cylinder, cone, pyramid, sphere, or combined shape of chamber 10b connected with piping 16 is applied as first plasma generation chamber 10 in FIG. 2 (D).

FIG. 2 (D) is the mode which used the chamber 10b of combined form of polygon, cylinder, cone, pyramid, sphere, or combined of them which piping 16 was connected as first plasma generation chamber 10.

The first plasma generation chamber 10 consists of the materials which can bear the generated plasma.

For example glass, quartz, metal such as stainless steel, ceramics such as alumina, silicon nitride, resin such as artificial resin, natural resin, clay, cement, genuine stone and artificial stone, crystal, and sapphire can be used.

It is desirable to use ceramics, such as silica, alumina, silicon nitride, silicon carbide, for the purity of plasma.

The gas feed opening 12 is connected to the piping 16 which is prolonged from not illustrated gas supply source, and supplies the first plasma gas at least to the first plasma generation chamber 10. Plasma gas is ionized by electric field and is made into plasma.

It is desirable to use rare gas, such as helium (He) gas, Argon (Ar) gas, xenon (Xe) gas or neon (Ne) gas as the first plasma gas, especially to use low dielectric breakdown voltage gas such as helium gas or argon gas is preferable as it enables to generate first plasma without using ignition apparatus.

When the first plasma generation chamber 10 is a part of piping 16 (FIGS. 2 (A), (B)), the upper end (hereafter in this specification, the upper and lower sides are based on a gas stream in principle) to the gas stream of the first plasma generation chamber 10 corresponds to the gas feed opening 12.

Moreover, by forming the gas feed opening 12 aslant to the side of the first plasma generation chamber 10, it may be constituted to flow through the first plasma gas spirally over the side. The side wall of the first plasma generation chamber 10 can be protected from the heat of plasma by flowing gas spirally over the side.

In addition, carrier gas may be supplied with the first plasma gas from the gas feed opening 12.

Moreover, when the second plasma gas to be described later, carrier gas, reactive gas, materials, or a sample used in the second plasma generation chamber 20 is supplied through the first plasma generation chamber 10, those gas is also supplied from the gas feed opening 12.

The plasma exit 13 is an exit of the plasma generated at the first plasma generation chamber 10.

The first plasma generated at the first plasma generation chamber 10 is taken out by moving the gas stream of plasma gas or carrier gas, or other means, or by expanding electric field effect from the plasma exit 13.

When the first plasma generation chamber 10 is a part of piping 16 (FIGS. 2 (A), (B)), the plasma exit 13 corresponds to gas flow downstream end or an upper end of plasma generation chamber 10.

From the plasma exit 13 to the plasma feed opening 22 of the second plasma generation chamber 20 should just be constituted so that the first plasma from the plasma exit 13 can be supplied in the second plasma generation chamber 20.

For example, as the plasma exit 13 may be connected with the second plasma generation chamber 20 as it is, or may connect with piping or separately prepared connecting tubule, or the composition as shown in FIG. 1 where the plasma feed opening 22 of the second plasma generation chamber 20 is countered the plasma exit 13 may be used.

Considering the stability of plasma, since plasma will become rapidly unstable when mixed other gas, it is desirable to connect the plasma exit 13 and the plasma feed opening 22 of the second plasma generation chamber 20 directly, or to connect them with piping or connecting tubule.

However, if the first plasma generated as plasma jet in the first plasma generation chamber, the plasma feed opening 22 of the second plasma generation chamber position can be estranged from the plasma exit 13 of the first plasma generation chamber 10 facing opened wide using jet-like emitting plasma of the first plasma generation chamber 10.

The first plasma generation means 11 including the electric power provider 14, and the first power supply 15 is arranged in the state where it does not expose to the first plasma generation chamber 10, and is able to generate plasma, without using exposed high-melting ignition apparatus to the space in the first plasma generation chamber 10.

As an electric power provider 14 of the first plasma generation means 11, for example, a pair of electrodes 14a and 14b can be used as shown in FIGS. 2 (A), (C), and (D), or a single electrode 14c (it is called a “mono electrode”) can be used as shown in FIG. 2 (B).

Low temperature, un-thermal balanced of high electron temperature and low gas temperature plasma can be generated by applying AC (not only sine wave but also including pulse wave etc.) high voltage to mono or a pair of electrode and resulting dielectric barrier electric discharge. (In this patent, plasma generation by impressing high voltage to a pair of or mono electrode is called “dielectric barrier electric discharge”. For example, a plasma generated in chamber of other material but dielectric material (metal, for example) by impressing AC high voltage is categorized “dielectric barrier discharge” of this patent.)

Although restriction increases in gas conditions, electric power, etc., inductively coupled plasma under normal pressure can generate at the first plasma generation chamber by using coil as an electric power provider 14 of the first plasma generation means 11, although not shown in FIG. 2.

Although typical state of non-exposure in the first plasma generation chamber 10 is in the state which has arranged the electric power provider 14 around outside of the first plasma generation chamber 10 as shown in FIGS. 2 (A) and (B), it may estrange electrodes as shown in FIG. 2 (C), or may bury the side wall of the first plasma generation chamber 10 as shown in FIG. 2 (D).

These electrodes may be enclose all of the plasma generation chambers 10 in total circularly (include wind around) or partially. Mono or a pair of electrode may be set of electrodes of the same potential.

Though mono or a pair of electrode are illustrated as first plasma generation means 11, the other method which does not expose to the space in the first plasma generation chamber 10, and can generate plasma without using ignition apparatus of high-melting metal are acceptable.

In addition, the combination of the first plasma generation chamber 10 and the first plasma generation means 11 in FIG. 2 (A) to (D) are examples, and may change combination, respectively.

Although the dielectric barrier electric discharge can generate plasma with an easy structure,

especially the plasma jet using the small diameter pipe and nozzle (preferably 10 mm or less in diameter, especially 2 mm or less) as first plasma generation chamber 10, and is elongated in the jet-shape by the first plasma generation means 11 to the inner side is desirable one.

In this case, although a plasma jet is formed, since plasma is prolonged on both upper and lower gas stream sides, it need to arrange the second plasma generation chamber 20 in neighbor. It is preferable to use a pair of electrodes which enables to expand the first plasma longer and fix its direction.

However, it is also possible to arrange the electrode (henceforth “the first bias electrode”) to orient for the extension direction of the first plasma to the lower stream or upper stream side also in the case of the single electrode 14c.

The first bias electrode has the function to affect in the extension direction of the first plasma by applying an earth potential, fixed potential, or AC. The first bias electrode may extend the first plasma to the direction where the first bias electrode has been arranged or opposite side.

When an earth electrode is used as the first bias electrode, it is tended in the direction of the first bias electrode to extend the first plasma. The first bias electrode may double as second plasma generation means, or may be arranged to the lower stream side across the second plasma generation chamber.

Furthermore, the first bias electrode may double as second bias electrode to be described later.

In addition, when the first plasma generation means has been arranged to the lower stream side rather than the second plasma generation chamber, the earth electrode as the first bias electrode is arranged rather than the first plasma generation means at the upper stream side.

When a pair of electrodes have been arranged on the outside of the plasma generation chamber 10, and the distance between electrodes is near, there is a possibility that current may flow and short circuit occurred between electrodes on the outside of the plasma generation chamber 10.

For this reason, the distance between electrodes needed to estrange 15 mm or more preferably 10 mm or more with the plasma jet generation device using a pair of conventional electrodes, so that the short circuit between a pair of electrodes may not occur.

However, when the distance between a pair of electrodes was separated, voltage required to generate plasma had to increase, and high impressing voltage is required.

In order to solve this problem, it is desirable to establish an insulated means between a pair of electrodes.

In FIG. 2 (A), the outside surface of a pair of electrodes 14a and 14b is covered by the insulated film 17 to insulate them.

In this case, only either one of 14a or 14b may be insulated by an insulated means.

In FIG. 2 (C), a pair of electrodes 14a and 14b is insulated by the insulated component 18 arranged between them.

In addition, in FIG. 2 (D), since a pair of electrodes 14a and 14b is laid under the side wall of the first plasma generation chamber 10, the side wall serves as an insulating means.

In addition, even a single electrode case as shown in FIG. 2 (B), insulating means may be arranged in order to prevent electric discharge between the second plasma generation means 21, and electric discharge with other surrounding components or an instrument.

For example, the distance between electrodes could be shorten to 10 mm or less 2 mm by applying an epoxy resin surface coating to seal a pair of electrodes, and plasma was able to be generated in low voltage.

The first power supply 15 supplies electric power in the first plasma generation chamber 10 through the electric power provider 14, which supplies the electric power according to the first plasma generation means 11.

When the electrode has been arranged as an electric power provider 14 of the first plasma generation means 11, the high voltage with a frequency of several Hz to several MHz is supplied.

Although these figures are suitably set up with the size of electric discharge space, the kind of the first plasma gas, flux, pressure, etc., desirable frequency is low frequency the range of 50 Hz-300 kHz, and desirable voltage to impress is the range of 1 kV-20 kV, in order to generate plasma jet.

When the electric power provider 14 is a pair of electrodes, one electrode may be fixed to fixed potential (include grounding is), and the electric power from the first power supply 15 may be supplied only to the other electrode of another side, or the electric power from the first power supply 15 may be supplied to both of a pair of electrodes.

Furthermore, you may establish the first cooling means for cooling the first plasma generation chamber 10 or/and from the plasma exit 13 of the first plasma generation chamber 10 to the second plasma generation chamber 20.

For example, piping which pours coolant may be established in the circumference of the first plasma generation chamber 10, the heat dissipation structure for air cooling may be established, or a heat dissipation fan may be established.

The second plasma generation chamber 20 has the plasma feed opening 22, and includes the plasma generation space which generates the second plasma by the second plasma generation means 21.

At least the first plasma generated at the first plasma generation chamber 10 is supplied to the second plasma generation chamber 20 through the plasma exit 13 and the plasma feed opening 22.

The second plasma generation chamber 20 may be a part of piping which circulates plasma gas as illustrated to FIG. 3 (A), or independently prepared a plasma generation chamber apart from piping, as illustrated to FIG. 2 (B) and (C).

FIG. 3 (A) shows the configuration which used piping 26 as second plasma generation chamber 20.

When using a part of piping 26 as second plasma generation chamber 20, where the second plasma generation means 21 is arranged is regarded as plasma generation chamber.

For example, in FIG. 3 (A), the domain between the dotted lines between coils 24a is considered as the second plasma generation chamber 20.

Moreover, the inside diameter may be thin at the tip of piping 26 that enables to expand plasma long.

Furthermore, using a part of straight portion of piping continuing from the first plasma generation chamber 10 as second plasma generation chamber 20 is desirable since the present invention is realized with simple device composition.

The plasma torch 20a connected with piping 26 as shown in FIG. 3 (B) or the chamber 20b of the form of polygon, cylinder, cone, pyramid, or form of combined them connected with piping 26 as shown in FIG. 3 (B) can be used as second plasma generation chamber 20.

Since usage of the plasma torch 20a or chamber 20b eases high electric power impression to the second plasma generation chamber 20, or to supply two or more kinds of gas, it is desirable to generate the high-density plasma which consists of various gases, or to obtain complicated plasma processing, and to perform the high flexibility device.

The second plasma generation chamber 20 consists of the quality of the materials which can bear the generated plasma.

For example glass, silica, metal such as stainless steel, ceramics such as alumina, silicon nitride, resin such as artificial resin, natural resin, clay, cement, genuine stone and artificial stone, crystal, and sapphire can be used.

It is desirable to use ceramics, such as silica, alumina, silicon nitride, silicon carbide, for the purity of plasma.

Although it seems that chamber 20b is sealed in FIG. 3 (C), the exhaust port which is not illustrated is prepared and the supplied gas is exhausted.

Although the first plasma is supplied from piping 26 in the composition shown in FIG. 3 (A) to (C), the composition is not limited this but for example, the plasma feed opening 22 may be connected at the tip of a plasma torch, or the plasma feed opening 22 may be made to counter when the first plasma generation chamber is a plasma torch.

Moreover, the plasma feed opening 22 may be formed cross aslant or right-angled to the gas stream of the second plasma gas supplied to the second plasma generation chamber 20 for supplying the first plasma.

For example, it is desirable to consider another gas course to generate the first plasma easily when the first plasma gas differs from the second plasma gas.

It was difficult to generate the first plasma when the liquid phases such as steam or micro drops was contained in the second plasma gas supplied through the first plasma generation chamber.

For this reason, it is desirable to supply the first plasma through a course different from the second plasma gas when the liquid phases such as steam and micro drops are used as the second plasma gas. Especially, the second plasma gas should be supplied linearly to the second plasma generation chamber to prevent condensation of the liquid phases such as steam and micro drops.

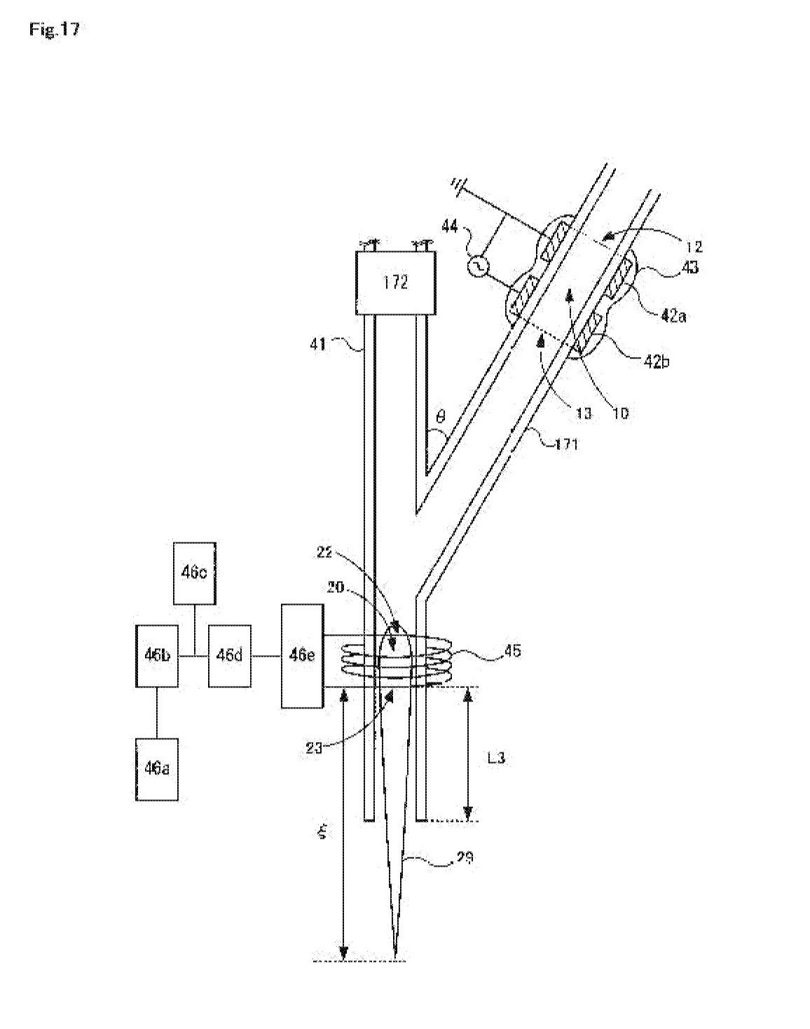

For example, as shown in FIG. 17 (this figure is mentioned later), it is desirable to configure the second plasma generation chamber 20 to supply the second plasma gas linearly and to supply the first plasma in cross aslant or right-angled to the second plasma gas flow.

Moreover, the upper stream side prolonged portion of the first plasma may be supplied to the second plasma generation chamber 20 by arranging the first plasma generation chamber 10 in the lower stream side of the second plasma generation chamber 20.

If the first plasma generation chamber 10 is arranged at the upper stream side, the second plasma generated at the second plasma generation chamber may develop to the upper stream side by the influence of the first plasma.

As for this point, when the first plasma generation chamber 10 is arranged in the lower stream side of the second plasma generation chamber 20, second plasma can be expanded to the lower stream side.

In this case, the upper end of the first plasma generation chamber 10 serves as a plasma exit of the first plasma, and the downstream end of the second plasma generation chamber 20 serves as a plasma exit of the second plasma, while serving as the plasma feed opening 22.

The second plasma generated at the second plasma generation chamber 20 may be emitted or taken out from the plasma exit 23 of the second plasma generation chamber 20 for plasma processing use as shown in FIG. 3 (A) and (B), or may be performed plasma processing in the second plasma generation chamber 20 as shown in FIG. 3 (C).

When emitting or taking out plasma from the second plasma generation chamber 20, hot plasma processing and low-temperature plasma processing can be properly used by adjusting the position of plasma and object to be processed.

That is, high temperature processing can be performed by locating object to be processed close to the plasma generation chamber 20, and by locating object away for low-temperature processing.

Moreover, the liquid phase may be located to the lower stream side of the gas stream of the second plasma generation chamber 20 by inserting the tip of the plasma torch which is the second plasma generation chamber 20, or the tip of piping which continues from the second plasma generation chamber 20 into liquid phase as case ξ=−2 of embodiment 2 and 3 to be described later. This enables to apply plasma processing by to liquid phase.

The plasma feed opening 22 is an entrance of supplied the first plasma generated at the first plasma generation chamber 10. When the second plasma generation chamber 20 uses a part of piping as shown in FIG. 3 (A), an upper end or a downstream end of second plasma generation chamber 20 corresponds to the plasma feed opening 22.

Moreover, the composition which supplies the second plasma gas, carrier gas, reactive gas, materials, or a sample from the plasma feed opening 22 may be used.

However, it is desirable the second plasma gas, carrier gas, reactive gas, materials, or a sample to be supplied separately.

In this case one or more gas feed ports 27 are established in the second plasma generation chamber 20 as shown in FIG. 3 (B) or (C), so that the second plasma gas, carrier gas, reactive gas, materials, or a sample may enable to supply independent or mixed.

The gas feed port 27 may be aslant formed to the side of the plasma generation chamber 20, so that the gas supplied in the second plasma generation chamber 20 may flow spirally over the side.

The side wall of the second plasma generation chamber 20 can be protected from the heat of plasma as gas flows spirally over the side.

For example, rare gas such as helium (He), argon (Ar), xenon (Xe) or neon (Ne), halogenated carbon such as chlorofluorocarbon, hydrofluorocarbon, perfluorocarbon, CF₄ or C₂F₆, gas for semiconductors such as SiH₄, B₂H₆ or PH₃, pure air, dry air, oxygen, nitrogen, hydrogen, steam, halogen, ozone or SF₆ of mono type, or mix of plural gases can be used as the second plasma gas.

The second plasma gas may be the same as the first plasma gas, and the first plasma gas that was not ionized at the first plasma generation chamber 10 may be used as the second plasma gas in the second plasma generation chamber 20.

Moreover, it is also suitable to use gas with high dielectric breakdown voltage compared with the first plasma gas as the second plasma gas.

For example, it is possible to use even the gas which does not generate plasma by supplied electric power from the first plasma generation means as the second plasma gas.

The carrier gas supplied to the first plasma generation chamber 10 and/or the second plasma generation chamber 20 is gas for carrying or diluting reactive gas, materials, a sample, etc., and it may be or not be ionized by electric field.

When carrier gas ionized and generated plasma, it is regarded as carrier gas from medium transfer or dilution, it also regarded as plasma gas as it generate plasma.

It is desirable to use carrier gas which has not an effect neither a reaction nor analysis.

For example, gas of the same constituent as first plasma gas or the second plasma gas or inactive gas can be used as carrier gas.

In addition, if reactive gas, materials, a sample, etc. are transportable in itself, it is not necessary to use carrier gas.

The second plasma generation means 21 which is arranged without exposed to the space in the second plasma generation chamber 20, contains the electric power provider 24 and the second power supply 25, and is used as the means for generating the second plasma in the second plasma generation chamber with the first plasma which is generated at the first plasma generation chamber 10.

It is desirable to apply conventionally plasma generation means of a non-electrode system by which plasma was generated using the ignition means using high-melting metal, as second plasma generation means 21.

For example, an coil 24a which generates inductive coupled plasma by supplying RF electric power as shown in FIGS. 3 (A) and (B), or wave guide 24b which generates microwave plasma by supplying microwave as shown in FIG. 3 (C) can be used. Especially, it is desirable the second plasma should be high temperature with high electron and gas temperature.

As the second plasma generation means 21 arranged near the first plasma generation means 11 may cause prolong the second plasma in the upper stream side, or may cause electric discharge on the outside of a reaction chamber between the first plasma generation means 11 and the second plasma generation means 21, it is desirable to keep away the second plasma generation means 21 from the first plasma generation means 11 in some extent.

In order to prevent prolonging the second plasma in the upper stream side, distance from the lower end of the first plasma generation means 11 to the upper end of the second plasma generation means 21 is preferably made longer than the plasma length of the second plasma prolonged from the second plasma generation means 21.

However this distance should be shorter than the length of prolonged first plasma generated by the first plasma generation means in range where the first plasma reaches.

Moreover, it is desirable to set the distance from the lower end (plasma exit 23) of the coil 24a of the second plasma generation means 21 to the tip of piping 26 in FIG. 3 (A) within the range of 5 mm-15 mm.

It was hard to generate the second plasma when the distance was shorter than 5 mm. It was observed the second plasma did not occur when the lower end of the second plasma generation means and the tip of piping were the same positions (0 mm).

As the second plasma is prolonged in both the upper stream and lower stream side in the case of the distance of longer than 15 mm, effective usage area is narrowed.

In a similar reason, it is desirable to set the distance from the lower end (plasma exit 23) of the coil 24a of the second plasma generation means 21 to the tip (plasma exit 23) of a plasma torch in FIG. 3 (B) within the range of 5 mm-15 mm.

The form of the second plasma generated at the second plasma generation chamber tends to be bound to the form at the generating time.

That is, when the second plasma initially prolonged in the upper stream and lower stream side, it had extended on both of the upper stream and the lower stream even after the electric power of the first plasma generation means and supply of the first plasma gas are stopped.

However, once weakening electric power from the second plasma generation means and making the second plasma small to the size about the inside of the plasma generation chamber 20, it is possible to extend the plasma prolonged on both sides to the lower stream side after electric power from the second plasma generation means is strengthened again and the second plasma is extended.

That means, though complicated work is required, the plasma form is controllable.

However, it is desirable to form plasma to extend in the lower stream side from the beginning to avoid this complicated work.

It is desirable to allocate an electrode (henceforth “the second bias electrode”) which orientates the extension direction of the second plasma to the lower stream side of the second plasma generation chamber since it enables to control the form of the second plasma to extend in the lower stream side.

The second bias electrode with an earth, fixed or AC potential has a function which extends the extension direction of the second plasma to its arranged direction.

The plasma generated at the second plasma generation chamber will tend to be prolonged in the upper stream side especially electric discharge power in the second plasma generation means becomes large.

For this reason, arranging a bias electrode to extend plasma in the lower direction is especially desirable when an electric discharge output is large.

Moreover, as mentioned above, arranging the first plasma generation chamber 10 in the lower stream side of the second plasma generation chamber 20 is desirable since the form of the second plasma is controllable to extend in the lower stream side.

In this case, the first plasma generation means is conjectured to function as the second bias electrode.

Thus, the second bias electrode can also be doubled by the first plasma generation means or can also be arranged to the lower stream side across the first plasma generation chamber.

Moreover, the second bias electrode may be doubled as first bias electrode.

The second power supply 25 supplies electric power to the second plasma generation chamber 20 through the electric power provider 24, and supplies the electric power (including by microwave means) according to the second plasma generation means 21.

The high voltage with a frequency of several MHz to 500 MHz needs to arrange as the second power supply 25, when coil 24a has been arranged as second plasma generation means 21.

Although these figures are suitably set up with the size of electric discharge space, the kind of the second plasma gas, flux, pressure, etc., preferably frequency range of 4 MHz-500 MHz, the electric discharge output range of 0.1 W-10 kW, more desirable the range of 5 W-500 W, most desirable as the range of 10 W-500 W is considered.

The microwave oscillator with a frequency of 300 MHz above as the second power supply 25, when waveguide 24b has been arranged as second plasma generation means 21.

As microwave, the frequency of 2.45 GHz is adopted widely.

Furthermore, it is desirable to establish the second cooling means for cooling the second plasma generation chamber 20.

For example, piping for coolant flow surrounding the second plasma generation chamber 20 may prepare or the second plasma generation means 21 may use coil 24a made of hollow conductive material with coolant flow.

Especially, when a nozzle-like plasma torch is used as second plasma generation chamber 20 as shown in FIG. 3 (B), arranging the coolant supply means 28 of composition of a coolant flowing into the circumference of a plasma torch along with a plasma torch, which emitting coolant in the same direction as the plasma jet at the tip of a nozzle is established to cool the plasma torch, it is effective in addition for stabilizing plasma since plasma is covered by the coolant and contamination of the open air is avoided.

Gas, a liquid, or a supercritical fluid may be sufficient as a coolant, and not only for cooling but may include a part of reaction materials and sample, or it may be a chemical fluid (for example, cleaning fluid and etchant) which processes object to be processed.

The plasma device of this invention enables to supply the first plasma which is generated by the first plasma gas supplied from the gas feed opening 12 at the first plasma generation chamber 10 and by supplying electric power from the first power supply 15 through the electric power provider 14 of the first plasma generation means 11, to the second plasma generation chamber 20 through the plasma exit 13.

Though the electric power from the second power supply 25 through the electric power provider 24 of the second plasma generation means 21 is supplied to the second plasma gas supplied from the plasma feed opening 22 or other feed openings in the second plasma generation chamber 20, plasma can be generated with smaller electric power by using the first plasma generated at the first plasma generation chamber 10 through the plasma exit 13 and the plasma feed opening 22.

For example, even the conditions which plasma does not generate only with the electric power supplied from the second plasma generation means 21, the second plasma generation chamber 20 was also able to generate plasma by supplying the plasma generated at the first plasma generation chamber 10.

Moreover, in the plasma device of this invention the first plasma generation means 11 is not exposed in the first plasma generation chamber 10, the second plasma generation means 21 is not exposed in the second plasma generation chamber 20, and since the ignition means of high-melting metal is not used in the first and second plasma generation chamber, very high purity plasma can be generated as the second plasma.

Since low-temperature plasma can be generated as the first plasma in the first plasma generation chamber 10 comparatively easily by using dielectric barrier electric discharge by the first plasma generation means 11, power dissipation can be decreased.

Although low-temperature plasma is low reactivity and small area size in itself, this invention can generate high density and high-temperature plasma such as inductive coupled plasma in the second plasma generation chamber 20 under normal pressure by using the low-temperature plasma as ignition means, and has the extensibility to the plasma processing by reactant high-density high temperature plasma.

Furthermore, since plasma jet generated as the first plasma by the first plasma generation means 11 which has a pair of electrodes can be prolonged in one direction, distance to the second plasma generation means 21 can be longer than a single electrodes one, and form of the second plasma can be stabilized.

In addition, the distance between a pair of electrode can be narrowed by establishing insulating means to prevent electric discharge between a pair of electrode outside the first plasma generation chamber 11, and generates the first plasma in less power dissipation.

Although it is also possible to generate inductively coupled plasma in the first plasma generation chamber 10 by the first plasma generation means 11 using coil, the conditions extremely limited to generate inductively coupled plasma under normal pressure without using an ignition means, especially the kind of the first plasma gas limited to helium gas or argon gas.

On the other hand the second plasma generation chamber 20, restriction of the second plasma gas becomes loose and it becomes possible including gas with higher dielectric breakdown voltage to generate various kinds of plasma.

The second plasma which is generated in the second plasma generation chamber 20 can also be considered as plasma higher-density than the first plasma and the plasma gas which is not able to generate plasma in normal condition of the first plasma generation means 11.

Especially the second plasma generation means 21 using coil can generates inductively coupled plasma in the second plasma generation chamber 20, and the plasma of the high-density electron density of about 10¹⁵ cm⁻³ can be generated under normal pressure as compared with the electron density which is about 10¹¹⁻¹² cm⁻³ of dielectric barrier electric discharge.

The second plasma was able to be generated not only using rare gas but using various plasma gas.

Since generation of the first plasma in the first plasma generation chamber 10 is needed at least at the initial ignition which generates the second plasma at the second plasma generation chamber 20, the first power supply 15 may be shut off, the electric power supply from the first plasma generation means 11 may be stopped, supply of the first plasma gas may be stopped, and generation of the first plasma may be stopped after the second plasma generation occurs.

As mentioned above, the plasma device in this invention can generate plasma with lower electric power by using the first plasma generated at the first plasma generation chamber 10 acting as an ignition means for generating the second plasma at the second plasma generation chamber 20.

By working of the plasma device of this invention, the plasma device of this invention is suitable to use the second plasma generation chamber 20 on the conditions under pressure higher than the normal pressure and normal pressure where plasma were not or were hard to generate by conventional art without using ignition means of exposed high-melting metal in plasma generation chamber.

The system of air opening was carried out is regarded as normal pressure unless controlled by device for pressure even the pressure becoming slightly high by gas supplied or slightly low by an exhaust means.

Even under normal pressure or pressurization, you may establish the exhaust means for exhausting the supplied gas.

Furthermore, also in a rough vacuum state (1.333×10⁴ Pa-1.013×10⁵ Pa), since it will be hard to generate plasma if there is no ignition means, it is desirable the plasma device of this invention.

As it is possible to generate plasma also in a vacuum state of 1.333×10⁴ Pa or less, the plasma device of this invention may be equipped with the vacuum pumping system which can be attained to a vacuum state of 1.333×10⁴ Pa or less.

Moreover, you may use the plasma device of this invention by the system opened wide, and by the closed system.

Though high purity plasma of little impurity can generate in the vacuum state, mixing of an impurity in plasma is avoided under normal pressure for example by replacing atmosphere to inert gas etc.

Since the plasma device of this invention can generate high-density plasma under normal pressure, it enables to perform plasma processing in the gas phase, the liquid phase, and the solid phase, and since it enables to supply the high purity plasma with few impurities, it can be applied in a wide range of fields.

For example, it can be applied for coat formation, etching, doping and washing etc. in fields such as a semiconductor industry and a display device production, or can be used for the reaction of a compound, composition, processing of a macromolecule, analysis of a sample, etc. in a chemical field.

In addition, processing of the metal, resin, plastics, etc. in the material processing field, resin, a plastic, etc. in surface modification field, and incinerated ashes, CFC chemicals, organic solvent and disposable or poorly soluble organic compound in processing field, sterilization, washing, deodorization and a cell culture in medical and bioscience field is expectable.

Moreover, the plasma device of this invention can be constituted combining for example one of FIG. 2 (A) to (D), and one of FIG. 3 (A) to (D).

Combination of the each first plasma generation chamber 10 and the first plasma generation means 11 in FIG. 2 (A) to (D) may alter arbitrarily, and combination of the each second plasma generation chamber 20 and the each second plasma generation means 21 in FIG. 3 (A) to (C) also alter arbitrarily.

As an example, the piping 26 in FIG. 3 (A), and wave guide 24d in FIG. 3 (C) may be combined as the second plasma generation chamber 20 and second plasma generation means 21.

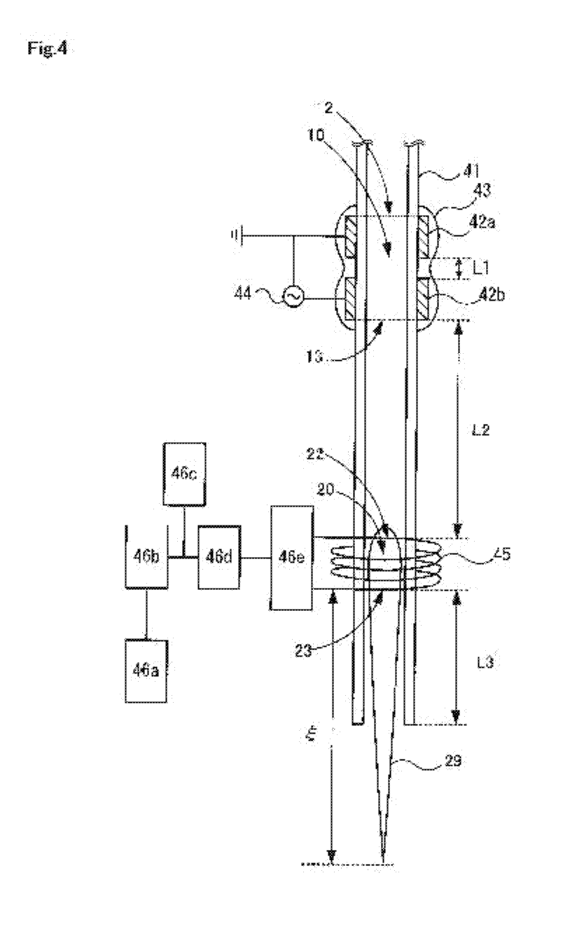

FIG. 4 is a schematic view showing one embodiment of the plasma processing device of specific invention.

By the upper stream side of the piping 41 made of one cylindrical (the inside diameter of 0.1-10 mm, preferably 0.5-2.0 mm) high-melting material (for example, silica), a pair of circular electrodes 42a and 42b are circulated around by piping 41 as the first plasma generation means, and the first AC power provider 44 of the low frequency (50 Hz-300 kHz) is connected to electrodes 42a and 42b in FIG. 4. The first plasma generation chamber 10 is divided with electrodes 42a and 42b.

The surface of a pair of cylindrical electrodes 42a and 42b is covered with the insulation material 43, which prevents electric discharge between the electrodes at the outside of piping 41.

Furthermore, in the lower stream side of piping 41, the coil 45 is arranged outside of piping 41 as second plasma generation means, and the DC power supply 46a, RF generator 46, isolator 46c (bypass function for backflow to RF generator), RF power monitor 46d and matching box 46e as the second power supply is connected to the coil 45.

The second plasma generation chamber 20 is divided with the coil 45. AC voltage generated by DC power supply 46a and RF generator 46b of preferably range of 1 MHz-500 MHz is supplied to the coil 45 through the matching box 46e. Supplying electric power is monitored by RF power monitor 46d and adjusted by matching box 46e.

Here, let L1 is the distance between a pair of electrodes, L2 is the distance from lower tip of the first plasma generation means (plasma exit 13) to the second plasma generation means (plasma feed opening 22), and L3 is the distance from the second plasma generation means (plasma exit 23) to the tip of piping 41 as shown in FIG. 4.

Without insulating means 43, the distance L1 between a pair of electrodes shall be 10 mm or more, and preferably 15 mm or more to avoid short circuit between a pair of electrodes. When the insulated means 43 is established, the distance L1 between a pair of electrodes may be 10 mm or less, and may be shorten up to 2 mm by using insulating means 43 of sufficient voltage endurance.

When L1 was 10 mm or more, the voltage of 10 kV or more was required, but when L1 was close to 5 mm the plasma can be generated even the voltage of 8 kV.

Moreover, since electric power is concentrated and supplied to a narrow domain when L1 is short, more stable plasma can be generated even the same voltage.

Although the distance L2 needs to make the first plasma generated at the first plasma generation chamber 10 reaches the plasma feed opening 22 of the second plasma generation chamber 20, since the second plasma 29 generated at the second plasma generation chamber 20 may be prolonged in the first plasma generation chamber 10 side (upper stream side) under the influence of the first plasma generation means 11 or the first plasma when distance L2 is too near, there is a possibility that the efficiency of the plasma processing by the side of the lower stream may become worse, or plasma processing may become impossible.

Although it depend on density and lifetime of the plasma generated at the first plasma generation chamber 10, as a result of experimenting on condition of plurality shows it was difficult for the length of the first plasma to be 100 mm or more from the lower end of the first plasma generation means, it is desirable to be referred to as 100 mm or less the maximum of the range of distance L2 when generating plasma in piping with a pair of electrodes as shown in FIG. 4.

Moreover, when the electric power supplied to the coil is small the minimum of the range of distance L2 can be short, but be longer for large electric power, preferably made longer than the plasma length of the second plasma prolonged from the second plasma generation means.

Though distance L3 is from the lower end (plasma exit 23) of coil 45 to the tip (plasma jet orifice) of piping 41, when the plasma exit 23 is a tip of piping (i.e., L3=0), the second plasma 29 may not ignite.

Moreover, when distance L3 is 17 mm or more, the second plasma 29 has been prolonged to the first plasma generation chamber 10 side (upper stream side). For this reason, it is desirable to consider L3 as the range of 5-15 mm.

By plasma generation method in the plasma device of FIG. 4, while passing the first plasma gas (a part including the second plasma gas) for piping 41, the AC voltage of the range of 0.1 W-10 kW preferably 20-50 W discharge output generated by the DC power supply 46a and the RF generator 46b is supplied to coil 45 through the matching box 46e.

It is difficult to generate plasma at the second plasma generation chamber 20 in this state.

Although plasma was able to be generated from helium gas at the second plasma generation chamber 20 under specific conditions, the second plasma generation chamber 20 is not able to generate plasma by the plasma generation method of this invention at this time.

Under the state where plasma has not generated at the second plasma generation chamber 20, impressing the pulse wave (low frequency of 50 Hz-300 kHz) of the 1-20 kV high voltage to a pair of circular electrodes 42a and 42b which is a part of first plasma generation means, then the first plasma by the first plasma gas can be generated at the first plasma generation chamber 10, and the first plasma is prolonged in the lower stream side inside of piping 41 and the second plasma generation chamber 20 is supplied through the plasma feed opening 22, then the second plasma 29 generated on condition of the comparatively large range also at the second plasma generation chamber 20.

Although the first plasma in the first plasma generation chamber 10 disappeared when supply of the pulse wave to a pair of circular electrodes 42a and 42b was stopped after the second plasma 29 generated, the second plasma 29 in the second plasma generation chamber 20 is maintained, and was able to continue plasma processing.

Although it is possible to generate the second plasma by supplying electric power to the second plasma generation chamber after the first plasma is generated at the first plasma generation chamber, since adjusting the stable electric power supply to the coil of the second plasma generation means takes time, the form of the second plasma has a possibility that abnormalities may arise or the second plasma may become unstable. By this reason, it is desirable to generate the first plasma at the first plasma generation chamber after adjusting the electric power from the second plasma generation means to a suitable value beforehand.

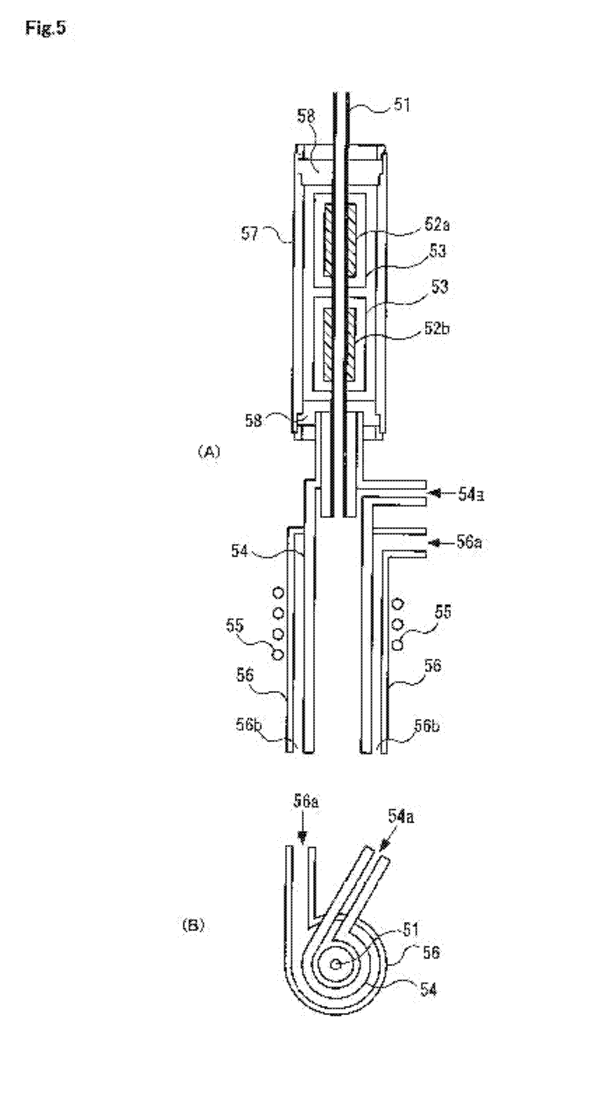

FIGS. 5 (A) and (B) are the schematic views showing another embodiments of the plasma processing device of this invention, (A) is an outline sectional view of a direction in alignment with a gas stream, and (B) is an outline sectional view of the direction which intersects perpendicularly with a gas stream. In the piping 51 which consists of one thin cylindrical (the inside diameter of 10 mm or less, preferably 2.0 mm or less) high-melting material (for example, silica) in FIG. 5, a pair of circular electrodes 52a and 52b are circulated around by piping 51 as first plasma generation means, and the first plasma generation chamber 10 is divided. A pair of cylindrical electrodes 52a and 52b, the surface of which is covered with the insulating material 53 is connected to the low frequency first AC power supply which is not illustrated.

Furthermore, piping 51 is connected with the plasma torch 54 (preferably inside diameter of 30 mm or less) which is the second plasma generation chamber at the lower stream side.

A plasma torch 54 has the gas feed port 54a for the direct inlet of the second plasma gas, process gas, the carrier gas, etc. without intervention of the first plasma generation chamber, and the hollow coil 55 is arranged outside as second plasma generation means.

In addition the second power supply (for example, the same one as FIG. 4) which is not illustrated is connected to the coil 55 and the range of 0.1 W-10 kW preferably 500-2000 W AC voltage is supplied as electric discharge output by the second power supply.

Also in the plasma processing device of FIG. 5, the distance from the lower end of the first plasma generation means to the second plasma generation means is longer than the plasma which is generated at the second plasma generation chamber in length from the second plasma generation means, and it is desirable to be as 100 mm or less like the device of FIG. 4,

Moreover, the distance from the lower end of coil to the tip of the plasma torch, it is desirable to be referred to as 5 mm-15 mm.

FIG. 5 (B) is an outline sectional view of the plane which intersects perpendicularly to the gas stream near the plasma feed opening of the plasma torch 54, The gas feed port 54a is aslant formed to the side of a plasma torch 54, and it is constituted as the gas supplied to the plasma torch 54 may flow spirally over the side, as shown in FIG. 5 (B).

Although the plasma torch 54 can generate the plasma of various gases by supplying large electric power, the side wall of the plasma torch 54 may be risked with the plasma heat.

When gas flows spirally over the side, the side wall of a plasma torch can be protected from the plasma heat.

Although the supplied gas becomes a turbulent flow easily, you may form the gas feed port 54a perpendicularly to the side of a plasma torch 54.

Moreover, although the plasma device of FIG. 5 has a cooling means by flowing coolant inside hollow coil 55, additional cooling means 56 is provided by flowing coolant between coil 55 and plasma torch 54 which refrigerates the plasma torch from outside.

The cooling means 56 consists of coolant feed port 56a and coolant injection tip 56b.

Coolant fed into the port 56a flows along with plasma torch 54 to cool the plasma torch 54 then injected from the injection tip 56b for covering the circumference of plasma.

The plasma is stabilized as its circumference is covered by coolant and difficult to mix open air etc.

Additionally, coolant may include part of reaction materials and samples or chemical liquid which processes the object to be processed (for example cleaning fluid and etchant).

Furthermore, in FIG. 5, the first plasma generation chamber 10 and the first plasma generation means (a pair of electrodes 52a and 52b) are surrounded with the insulated protection pipe 57 and the insulating board 58, and are insulated from the circumference.

Although the surface of a pair of electrodes 52a, and 52b is covered with the insulation material 53 to prevent electric discharge between them, it is desirable to improve insulation with the insulated protection pipe 57 and the insulating board 58 to prevent electric discharge between the first plasma generation means and among other components, for example the second plasma generation means (coil) on the outside of piping 51 or a plasma torch 54.

Insulating polymer material for example PEEK (polyether ether ketone) material, fluoro-resin, epoxy resin, silicone resin, etc. can be used as the insulating material 53, the insulated protection pipe 57, and an insulating board 58.

More improved insulation is obtained by enclosing insulating component, then sealing the crevice by insulating resin.

The plasma generation method in the plasma device of FIG. 5 passes the first plasma gas for piping 51 first, then passes the second plasma gas from the gas feed port 54a to the plasma torch 54 and AC voltage is supplied to the coil 55 from the power supply which is not illustrated.

It is difficult to generate plasma by torch 54 in this state. Although plasma can be generated from helium gas at the plasma torch 54 under specific conditions, a plasma torch 54 is not made to generate plasma by the plasma generation method of this invention at this time.

By impressing the high voltage of 1-20 kV pulse wave (low frequency of 50 Hz-300 kHz) to a pair of circular electrodes 52a and 52b under the state plasma not having generated at the plasma torch 54, the first plasma by the first plasma gas can be generated at the first plasma generation chamber 10, then the first plasma is prolonged in the lower stream side inside of piping 51 and supplied to the plasma torch 54. Then the second plasma by the second plasma gas can be generated by the plasma torch 54.

After the second plasma generated by the plasma torch 54, supply of the pulse wave to a pair of circular electrodes 52a and 52b was stopped and supply of the first plasma gas to piping 51 was also further stopped, the second plasma generation chamber 20, the second plasma by the second plasma gas was able to be maintained.

Since supply of the pulse wave was stopped, and supply of the first plasma gas was also stopped, the first plasma in the first plasma generation chamber 10 has disappeared.

In addition, it is also possible to supply electric power and the second plasma gas to the second plasma generation chamber, and to generate the second plasma after the first plasma is generated at the first plasma generation chamber, since adjusting the stable electric power supply to the coil of the second plasma generation means takes time, the form of the second plasma to generate has a possibility of abnormalities may arise or the second plasma may become unstable.

For this reason, it is desirable to generate plasma at the first plasma generation chamber after adjusting the electric power from the second plasma generation means to a suitable value beforehand.

With the plasma device of FIG. 5, the first plasma gas and the second plasma gas can be changed, and the plasma which consists of differed gas can be generated by each the first plasma generation chamber 10 and the plasma torch 54 which are the second plasma generation chamber.

Since the plasma torch 54 is especially equipped with the cooling means 56 etc., it is possible to impress large electric power and to use various gas into the second plasma.

For this reason, the first plasma is generated as the first plasma gas at the first plasma generation chamber 10 using helium gas and argon gas which plasma tends to generate under normal pressure, and as the second plasma gas, which plasma does not generate easily under normal pressure, for example, oxygen gas, nitrogen gas, air, etc. may be used, and such second plasma may be generated with a plasma torch 54.

In addition, in the plasma device of FIG. 5, although the piping 51 which is the first plasma generation chamber has been arranged in the longitudinal direction of a plasma torch, this may be arranged in different position.

For example, piping connected to the gas feed port 54a of FIG. 5 may be as first plasma generation chamber, and also another plasma feed opening may be established in a plasma torch.

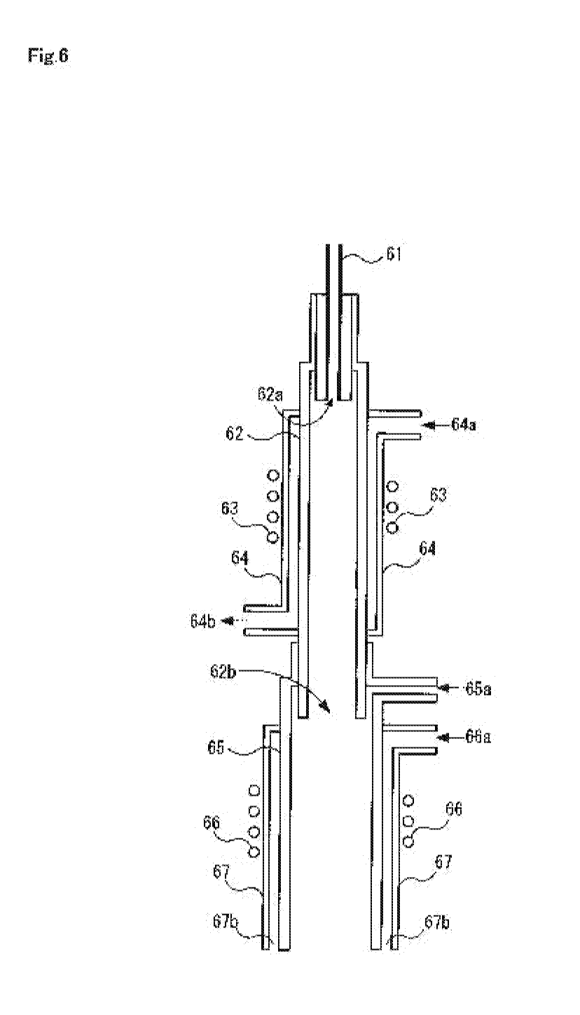

FIG. 6 is a schematic view showing another embodiment of the plasma processing device of this invention, and is an outline sectional view of the plasma processing device of direction aligned with gas stream.

The plasma processing device of FIG. 6 is the composition of combined the first plasma torch 62 as the first plasma generation chamber, and the second plasma torch 65 as the second plasma generation chamber.

It has the first plasma torch 62 (preferably inside diameter of 20 mm or less) to which piping 61 was connected, and the hollowed coil 63 is arranged outside of the first plasma torch 62 as first plasma generation means.

The exit of piping 61 is the gas feed opening 62a of the first plasma torch 62.

The first power supply (for example, the same as second power supply 46 a-e of FIG. 4) which is not illustrated is connected to the coil 63, and AC voltage is supplied from the first power supply.

Although the coil 63 has a cooling means to cool by flowing coolant inside, a cooling means 64 to cool the first plasma torch from the outside is established between coil 63 and the first plasma torch 62 by flowing coolant.

The cooling means 64 has the coolant feed port 64a and outlet 64b, and the coolant introduced from the coolant feed port 64a flows along with the first plasma torch 62 for cooling the torch, then discharged from outlet 64b.

The plasma exit 62b of the first plasma torch 62 is connected with the second plasma torch 65 as corresponding to the plasma feed opening of the second plasma torch 65.

It is desirable the inside diameter of the second plasma torch 65 is larger than the first plasma torch 62.

The second plasma torch 65 has the gas feed port 65a for the direct inlet of the second plasma gas, process gas, the carrier gas, etc. without intervention of the first plasma generation chamber, and the hollowed coil 66 is arranged outside as second plasma generation means.

In addition, the second power supply (for example, the same as FIG. 4) which is not illustrated is connected to the coil 66, and AC voltage is supplied from the second power supply.

Although the coil 66 has a cooling means by flowing coolant inside, a cooling means 67 by flowing coolant to cool the second plasma torch from the outside is established between coil 66 and the second plasma torch 65.

The cooling means 67 has the coolant feed port 67a and the coolant exhaust nozzle 67b.

The introduced coolant from the coolant feed port 67a may flow along with the second plasma torch 65, and the second plasma torch 65 may be cooled and also the circumference of plasma may be covered from the coolant exhaust nozzle 67b tip.

As the coolant covers the circumference, it prevents to mix the open air etc. into plasma, and plasma becomes stable.

Additionally, coolant may include part of reaction materials and samples or chemical liquid which processes the object to be processed (for example cleaning fluid and etchant).

Like FIG. 5 (b), the gas feed port 65a is aslant formed to the side of the second plasma torch 65, and it is desirable to be constituted as the gas supplied in the second plasma torch 65 may flow spirally over the side.

Although the second plasma torch 65 can generate the plasma of various gases by supplying large electric power, the side wall of the second plasma torch 65 may be risked with the plasma heat.

However, when gas flows spirally over the side, the side wall of the second plasma torch 65 can be protected from the plasma heat.

Although the supplied gas becomes a turbulent flow easily, you may form the gas feed port 65a perpendicularly to the side of the second plasma torch 65.

The plasma generation method in the plasma device of FIG. 6, the first and second power supplies which are not illustrated are adjusted to supply stable electric power to each of the coil 63 which is the first plasma generation means and the coil 63 which is the second plasma generation means.

Although the second plasma gas is passed from the gas feed port 65a to the second plasma torch 65, it is difficult to generate plasma at the plasma torch 54 in this state.

Plasma can be generated from helium gas in the second plasma torch 65 under specific conditions, the second plasma torch 65 is not made to generate plasma by the plasma generation method of this invention at this time.

In the state where plasma has not generated in the second plasma torch 65, the first plasma gas is supplied to the first plasma torch 62 through the gas feed opening 62 from piping 61, and the first plasma by the first plasma gas is generated in the first plasma torch 62, then the first plasma is supplied to the second plasma torch 65, and the second plasma by the second plasma gas is generated in the second plasma torch 65.

For example, the first plasma torch can generate plasma from helium gas in specific condition without ignition means.

After the second plasma occurred with the second plasma torch 65, the first power supply was shut off, supply of the first plasma gas was also stopped, and the first plasma of the first plasma torch 62 was erased, but, the second plasma by the second plasma gas was able to be maintained in the second plasma torch 65.

With the plasma device of FIG. 6, the first plasma gas and the second plasma gas can be changed, and the plasma which consists of gas different each with the first plasma torch 62 and second plasma torch 65 can be generated.

Since the second plasma generation means of the first plasma generation means is also the same in this case of the operation, it is easy to make the first power supply and second power supply shared, and miniaturization of device and cost reduction can be attained.

Moreover, a cooling means 64 to cool the first plasma, and a cooling means 67 to cool the second plasma torch 65 may be connected to realize one cooling means.

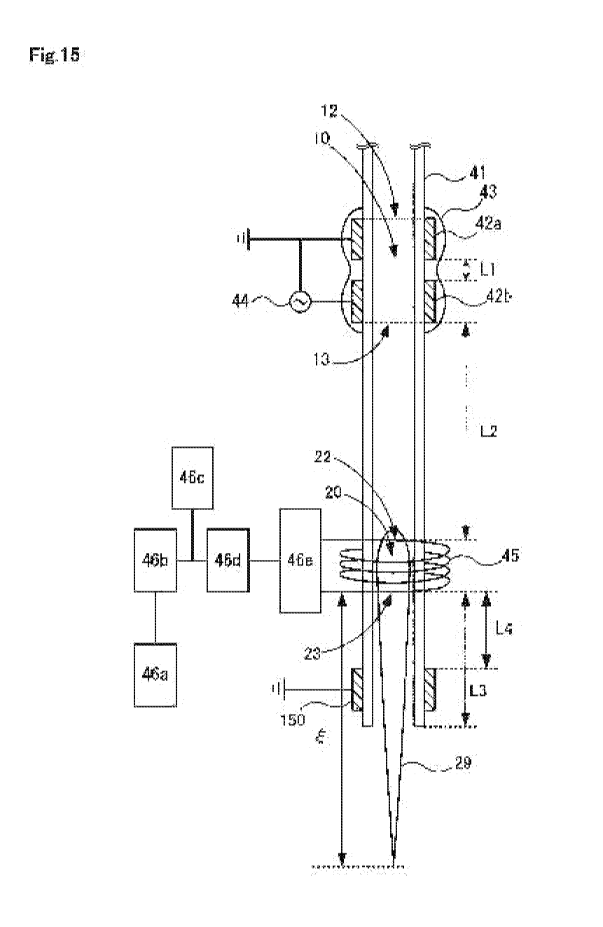

FIG. 15 is a schematic view showing another embodiment of the plasma processing device of this invention, and is an outline sectional view of a direction aligned with the gas stream of the plasma processing device which formed the bias electrode 150 in the lower stream side of the second plasma generation chamber.

The plasma processing devices shown in FIG. 15 to FIG. 17 are modifications of the plasma processing device of FIG. 4 and though the same mark as FIG. 4 is assigned to the composition which is common in FIG. 4, this assignment is also allocable not only limited to the feature which transformed the plasma processing device of FIG. 4 but the plasma processing device of other feature including the plasma processing device of FIG. 5 or FIG. 6.

The bias electrode 150 is grounded or connected to the power supply which is not illustrated, and an earth potential, fixed potential, or AC voltage is impressed.

With the potential of a bias electrode, the first or second plasma can be expanded to the lower stream side.

The bias electrode 150 may be applied for the first plasma, the second plasma, or both of plasma.

In FIG. 15, the bias electrode 150 is formed at the lower stream side of the second plasma generation chamber separated from the downstream end by distance L4.

It is not desirable the bias electrode 150 is too close to the second plasma generation chamber, since an electric discharge phenomenon etc. will arise between the bias electrode 150 and the second plasma generation means 45.

By this reason, it is desirable to consider the distance of an electric discharge phenomenon does not produce as distance L4, referred to as 3 mm or more. The bias electrode 150 may be grounded by connecting to the housing of plasma processing device.

In addition, in order to prevent the electric discharge phenomenon between the second plasma generation means 45, the bias electrode 150 may be surrounded by insulating film.

It is desirable the bias electrode 150 is arranged without exposing to the piping 41 space to prevent contamination of plasma. However it may contact to the plasma after finishing plasma processing.

A bias electrode may be annular enclosing all around of piping 41 (winding electric wire is included) in term of shape, and may be provided partially.

In addition, the bias electrode 150 may be buried in the holder of processing object, or may be arranged in the domain covered with the processing object, or may prepared as meshed electrode in the lower stream side of space to be processed.

Since the bias electrode 150 exists, the plasma device of FIG. 15 can expand the first plasma generated at the first plasma generation chamber 10 to the lower stream side, or can expand the second plasma generated at the second plasma generation chamber 20 to the lower stream side.

So, a part of restriction of distance L1, L2, and L3 can be eased. Especially, though the second plasma will come to be prolonged in the upper stream side as the electric power supplied from the second plasma generation means 45 becomes large, it can be elongated to the lower stream side, and can be used as the plasma processing device of large electric power by forming the bias electrode 150.

In FIG. 15, since the bias electrode is grounded, bias electrode provides bias to the first plasma or second plasma when generating the first plasma, when generating the second plasma and even after the second plasma generated.

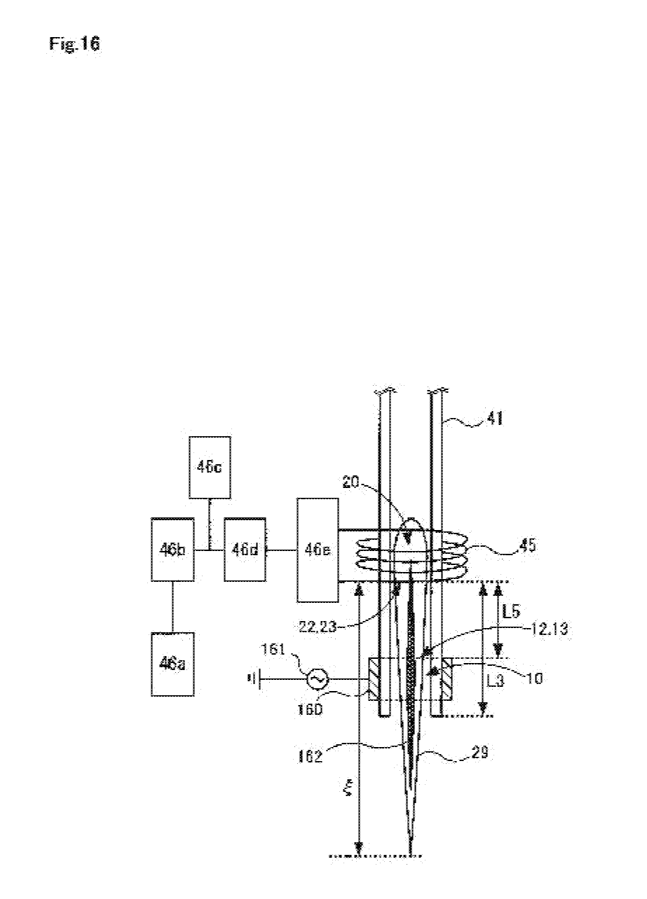

FIG. 16 is a schematic view showing another embodiment of the plasma processing device of this invention, and is an outline sectional view of a direction aligned with the gas stream of the plasma processing device which has arranged the first plasma generation chamber 10 to the lower stream side of the second plasma generation chamber 20.

In FIG. 16, it has the first power supply 161 connected to the single electrode 160 prepared in the circumference of piping 41, and the single electrode 160 as first plasma generation means in the first plasma generation chamber 10.

Since plasma jet 162 (shaded in FIG. 16) by the single electrode 160 is prolonged on both of the upper stream and the lower stream sides, the first plasma can be supplied to the second plasma generation chamber 20 arranged at the upper stream side.

For this reason, at the first plasma generation chamber 10 of FIG. 16, its upper end to the gas stream is corresponded to the plasma exit 13, and also served as the gas feed opening 12. Moreover, at the second plasma generation chamber 20 of FIG. 16, its downstream end to a gas stream is corresponded to the plasma feed opening 22, and also served as the plasma exit 23 of the second generated plasma. Although distance L5 from the upper end of the single electrode 160 to the plasma exit 23 of the second plasma generation chamber 20 is sufficient within the plasma jet 162 by the single electrode 160 reaches, it is not desirable the single electrode 160 which is too close to the second plasma generation chamber 20 since an electric discharge phenomenon etc. will arise between the single electrode 160 and the second plasma generation means 45.

For this reason, though it depend on conditions, it is desirable to consider the distance which an electric discharge phenomenon does not produce as a distance L5, referred to as 3 mm or more.

In addition, the circumference of the single electrode 160 may be covered with insulating film to prevent the electric discharge phenomenon between the second plasma generation means 45.

When the first plasma generation chamber 10 had been arranged to the upper stream side, the second plasma generated at the second plasma generation chamber 20 might develop also to the upper stream side depending on conditions.

As mentioned above, it is assumed this phenomenon is related to many conditions including the distance L2 of the first plasma generation means and the second plasma generation means, the influence of the first plasma generation chamber 10 arranged at the upper stream side as one of the causes.

By arranging the first plasma generation chamber 10 to the lower stream side of the second plasma generation chamber 20 as shown in FIG. 16, it was able to prevent elongating the second plasma to the upper stream side.

In addition, although the single electrode 160 was used as first plasma generation means in FIG. 16, a pair of electrodes may be used.

FIG. 17 is a schematic view showing another embodiment of the plasma processing device of this invention, and is an outline sectional view of a direction aligned with the gas stream of the plasma processing device which can supply the first plasma as cross aslant or right-angled to the second plasma gas flow.

With the plasma processing device of FIG. 17, the piping 171 of the first plasma generation chamber 10 is aslant connected to the piping 41 of the second plasma gas.

Furthermore, in FIG. 17, the liquid phase content means 172 is established in the middle of the piping 41 of the second plasma gas.

The piping 41 of the second plasma gas, and piping 171 of the first plasma generation chamber 10 is connects with by the upper stream side of the second plasma generation chamber 20, and the first plasma joins aslant or right-angled to the gas stream of the second plasma gas, and is supplied to the second plasma generation chamber 20 through the plasma feed opening 22.

Although the angle θ between the piping 41 of the second plasma gas and the piping 171 of the first plasma generation chamber 10 is set up suitably the ease of elongating of the first plasma, and not to disturb the gas stream of the second plasma gas, it is desirable to consider it as the range of 15-60 degrees.

In addition, the distance from the plasma exit 13 of the first plasma generation chamber 10 to the plasma feed opening 22 of the second plasma generation chamber 20 is necessary to consider similarly as the distance L2 of FIG. 4 in which the first plasma generated at the first plasma generation chamber 10 reaches the plasma feed opening 22 of the second plasma generation chamber 20.

In this feature of preferred embodiment, since the piping 171 of the first plasma gas and the piping 41 of the second plasma gas are different courses, plasma gas suitable for the first and the second plasma can be supplied, respectively.

Especially, when the liquid phases, such as steam and micro drops, were contained as the second plasma gas and the second plasma gas was supplied to the first plasma generation chamber 10, it was difficult to generate the first plasma.

For this reason, as shown in FIG. 17, the piping 171 of the first plasma gas and piping 41 of the second plasma gas are made as different course, so the second plasma gas was not supplied to the first plasma generation chamber 10.

The liquid phase content means 172 is a means by which the liquid phases, such as steam and micro drops, can be contained in gas, for example, a mist generator and a steam generator can be used for it.

### Embodiment 1

In this embodiment, the status of the plasma by changing various kinds of parameters at normal pressure and normal temperature was confirmed in the plasma device of configuration shown in FIG. 4.

Piping 41 used the silica tube 41 with inside diameter of 1.5 mm, and the specific configuration of plasma device has arranged a pair of circular copper electrodes 42a and 42b in concentric by intervals of L1=5 mm to the upper stream side of the silica tube 41.

As the length of one copper electrode was 10 mm, the first plasma generation chamber 10 is a 25 mm domain of the silica tube 41 along with a pair of copper electrodes 42a and 42b.

The coil 45 (3 turns, 15 mm length alongside of silica tube) made of hollow 3 mm copper has been arranged around at the lower stream side of the silica tube 41.

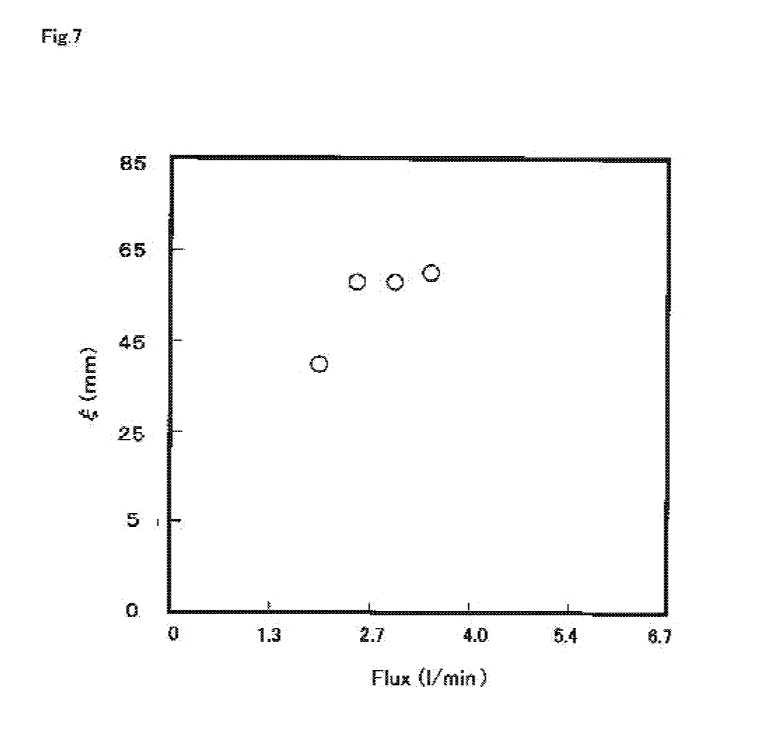

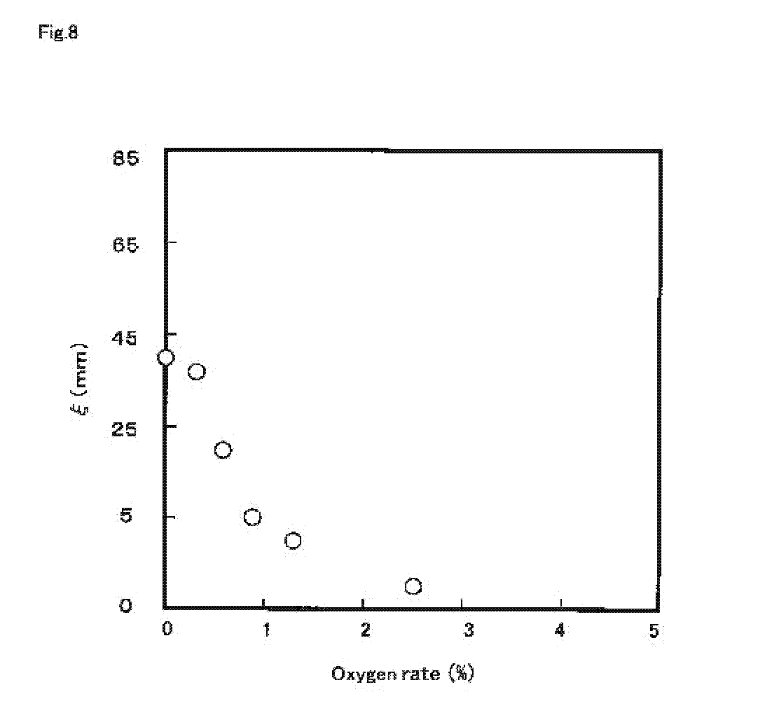

The distance L2 from the lower copper electrode 42b to the copper coil 45 was variable in Tables 2 and 3, and was 35 mm in Table 4, 50 mm in Table 5, Table 6, FIG. 7 and FIG. 8.

In addition, the cooling water is circulated in the hollow copper coil 45. The distance L3 from the lower end of the copper coil 45 to the tip of the silica tube 41 was fixed 10 mm in Table 2, Table 3, Table 6, FIG. 7 and FIG. 8, and was variable in Table 4 and Table 5.

Argon (Ar) gas was used as plasma gas in Tables 2-6 and FIG. 7, and the mixed gas of argon gas and oxygen gas was used in FIG. 8.

The flux of argon gas was fixed as 3.0 l/min (by the way, 1.0 l/min of flux is equal to 0.74 millimole/sec) in Table 3-5, was variable in Table 6 and FIG. 7.

The flux of mixed gas was fixed as 2.0 l/min and oxygen rate was variable in Table 8.

The pulse wave of 10 kHz AC was impressed to a pair of copper electrodes 42a and 42b about 1 second duration at the ignition time which generates plasma by the second plasma generation means.

The copper electrode 42a by the side of the upper stream was grounded, the AC pulse wave, voltage of ±16 kV was impressed to the copper electrode 42b by the side of the lower stream in Tables 2-6, the copper electrode 42a by the side of the upper stream was grounded, and the AC pulse wave, voltage of ±9 kV was impressed to the copper electrode 42b by the side of the lower stream in FIG. 7 and FIG. 8.

Moreover, RF wave of 144.2 MHz was impressed with the electric power of 20 W in Table 2 and Table 4, with the electric power of 50 W in other cases to the copper coil 45 which is a part of second plasma generation means.

The status of plasma was evaluated by length from the lower end of the copper coil 45 to the tip of plasma (“plasma length from the second plasma generation means”) when the second plasma occurred in the shape of a jet in Tables 2-6.

The conditions of each parameter in Tables 2-6 and FIGS. 7 and 8 were shown in Table 1.

TABLE 1

| | | Oxygen | Flux | 1st Power | 2nd Power | | |
|---|---|---|---|---|---|---|---|
| | Gas | rate | (l/min) | Volt.(kV) | Pow. (W) | L2 (mm) | L3 (mm) |
| Tbl. 2 | Ar | 0 | 3 | 16 | 20 | variable | 10 |
| Tbl. 3 | Ar | 0 | 3 | 16 | 50 | variable | 10 |
| Tbl. 4 | Ar | 0 | 3 | 16 | 20 | 35 | variable |
| Tbl. 5 | Ar | 0 | 3 | 16 | 50 | 50 | variable |
| Tbl. 6 | Ar | 0 | Variable | 16 | 50 | 50 | 10 |
| FIG. 7 | Ar | 0 | Variable | 9 | 50 | 50 | 10 |
| FIG. 8 | Ar + O₂ | Variable | 2 | 9 | 50 | 50 | 10 |

Table 2 is the result of varying L2 in 10-105 mm when the electric power of 20 W was supplied to the copper coil 45 in 10-105 mm, and Table 3 is the result of varying L2 in 40-110 mm when the electric power of 50 W was impressed.

TABLE 2

| Flux (l/min) | Power (W) | L2 (mm) | L3 (mm) | ζ (mm) |
|---|---|---|---|---|
| 3 | 20 | 10 | 10 | Plasma was ignited |
| | | | | backward |
| 3 | 20 | 15 | 10 | 20 |
| 3 | 20 | 20 | 10 | 20 |
| 3 | 20 | 25 | 10 | 20 |
| 3 | 20 | 30 | 10 | 21 |
| 3 | 20 | 35 | 10 | 25 |
| 3 | 20 | 40 | 10 | 22 |
| 3 | 20 | 45 | 10 | 23 |
| 3 | 20 | 50 | 10 | 20 |
| 3 | 20 | 55 | 10 | 20 |
| 3 | 20 | 60 | 10 | 20 |
| 3 | 20 | 65 | 10 | 20 |
| 3 | 20 | 70 | 10 | 21 |
| 3 | 20 | 75 | 10 | 20 |
| 3 | 20 | 80 | 10 | 20 |
| 3 | 20 | 85 | 10 | 20 |
| 3 | 20 | 90 | 10 | 21 |
| 3 | 20 | 95 | 10 | 20 |
| 3 | 20 | 100 | 10 | 19 |
| 3 | 20 | 105 | 10 | Plasma was |
| | | | | not ignited |

TABLE 3

| Flux (l/min) | Power (W) | L2 (mm) | L3 (mm) | ζ (mm) |
|---|---|---|---|---|
| 3 | 50 | 40 | 10 | Plasma was ignited |
| | | | | both sides |
| 3 | 50 | 50 | 10 | 58 |
| 3 | 50 | 60 | 10 | 58 |
| 3 | 50 | 80 | 10 | 51 |
| 3 | 50 | 90 | 10 | 55 |
| 3 | 50 | 100 | 10 | 50 |
| 3 | 50 | 110 | 10 | Plasma was |
| | | | | not ignited |

Result from Table 2 and 3 that the second plasma will occur also in back side (upper stream side) when distance L2 is too near, and since the second plasma will not occur when distance L2 is too far, shows existence of maximum and minimum value in the distance L2 from the lower copper electrode 42b to the copper coil 45.

As the lower limit value was varied with the electric power supplied to the copper coil 45 which is the second plasma generation means, and since it was 10 mm when the electric power supplied to the copper coil 45 is 20 W while it was 40 mm for the electric power of 50 W. The value is varies by supplied electric power and when electric power is large, it is large, and when small, it turns out small.

And as for the lower limit of distance L2, since ξ was 20 mm-25 mm in Table 2 and ξ is 50 mm-58 mm in Table 3, it is desirable to make it longer than plasma length ξ from the second plasma generation means. Moreover, upper limit value was almost the same in Table 2 and Table 3 and was not involved in the electric power supplied, it is desirable to be referred to as 100 mm or less.

Table 4 is the result of varying L3 in 0-17 mm when supplying the electric power of 20 W to the copper coil 45, and Table 5 is the result of varying L3 in 0-30 mm when the electric power of 50 W.

TABLE 4

| Flux (l/min) | Power (W) | L2 (mm) | L3 (mm) | ζ (mm) |
|---|---|---|---|---|
| 3 | 20 | 35 | 0 | Plasma was |
| | | | | not ignited |
| 3 | 20 | 35 | 5 | 15 |
| 3 | 20 | 35 | 10 | 25 |
| 3 | 20 | 35 | 15 | 25 |
| 3 | 20 | 35 | 17 | Plasma was ignited |
| | | | | both sides |

TABLE 5

| Flux (l/min) | Power (W) | L2 (mm) | L3 (mm) | ζ (mm) |
|---|---|---|---|---|
| 3 | 50 | 50 | 0 | Plasma was ignited |
| | | | | both sides |
| 3 | 50 | 50 | 5 | 58 |
| 3 | 50 | 50 | 10 | 58 |
| 3 | 50 | 50 | 15 | 55 |
| 3 | 50 | 50 | 20 | Plasma was ignited |
| | | | | both sides |
| 3 | 50 | 50 | 30 | Plasma was ignited |
| | | | | both sides |

According to Table 4 and 5, the second plasma generates neither both cases when distance L3 is 0 mm, so it is desirable the distance L3 is referred to as 5 mm or more.

On the other hand, since the second plasma occurred also back side (upper stream side) in Table 4 and Table 5 when the distance L3 from the lower end of the copper coil 45 to the tip of the silica tube 41 is too long, it is desirable the distance is referred to as 15 mm or less.

Table 6 is the result of varying the flux of argon gas in the range of 2.5-4.5 l/min.

TABLE 6

| Flux (l/min) | Power (W) | L2 (mm) | L3 (mm) | ζ (mm) |
|---|---|---|---|---|
| 2.5 | 50 | 50 | 10 | 58 |
| 3 | 50 | 50 | 10 | 58 |
| 3.5 | 50 | 50 | 10 | 60 |
| 4 | 50 | 50 | 10 | Plasma was ignited |
| | | | | both sides |
| 4.5 | 50 | 50 | 10 | Plasma was ignited |
| | | | | both sides |

Table 6 shows, since the second plasma will have occurred also back (upper stream side) by too much flux of argon gas, a maximum exists as for the flux of argon gas.

According to Table 6, it is desirable flux of argon gas is at least as 3.5 l/min.

Although it is not experimented with flux by 2.5 l/min or less in Table 6, since the second plasma will become small by decreasing plasma argon gas, it is expected that the flux of argon gas has a lower limit.

FIG. 7 is the graph which shows ξ value by varying the flux of argon gas in range of 2.0-3.5 l/min with the voltage of ±9 kV impressed between a pair of copper electrodes 42a, and 42b.

It is observed the plasma length is rapidly shortened by 3.0 l/min in FIG. 7, which supports existence of a lower limit, and it is desirable to consider the value as the above 2.0 l/min.

Moreover, as the plasma length of ξ generated at the second plasma generation chamber is almost the same in Table 6 and FIG. 7 for 2.5-3.5 l/min, length ξ of the plasma generated at the second plasma generation chamber is not related to the voltage impressed to the first plasma generation means.

The graph FIG. 8 shows value of ξ by varying the rate of the oxygen gas in range of 0 to 2.5% using the mixed gas of argon gas and oxygen gas as plasma gas.

FIG. 8 shows the second plasma will become short by increasing oxygen rate, and stop when the rate exceeds 2.5%.

However, it is possible to generate plasma, by enlarging electric power supplied to coil 45 even the percentage of oxygen is 2.5% or more.

### Embodiment 2

In this embodiment, the plasma device of configuration shown in FIG. 4 was used, and plasma processing of the ion-exchanged water was carried out by the argon gas plasma generated in normal pressure.

The argon gas plasma was generated by the embodiment 1 in FIG. 7 on the condition of 2.0 l/min.

20 ml of ion-exchanged water was put in the glass reaction vessel maintained as 298K by the constant temperature bath, and the plasma jet orifice at the tip of the silica tube 41 has been arranged to the surface of the processed object, ion-exchanged water.

The distance δ from the tip of the silica tube 41 to the surface of water was considered as variable in the range of −2 mm-10 mm, where δ=−2 mm was in the state of tips of the silica tube 41 underwater in −2 mm.

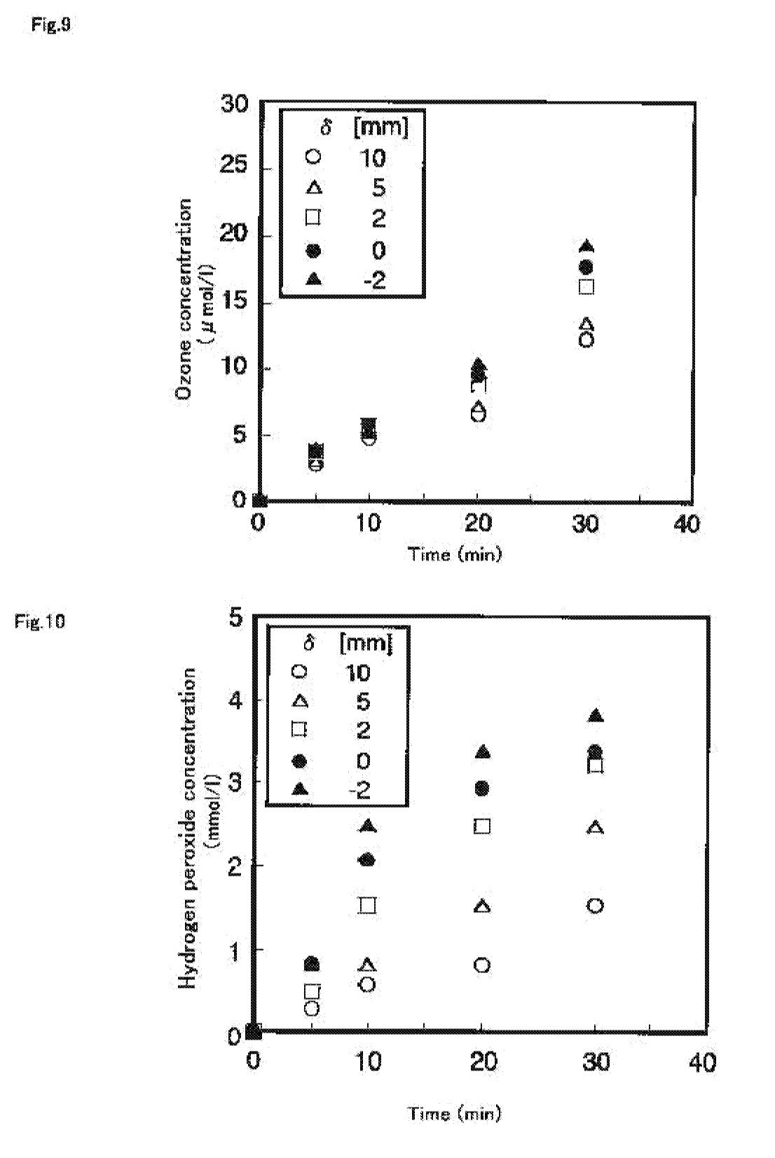

FIG. 9 is the graph which shows the relation between the plasma irradiation time and ozone (O₃) concentration (micromole) when the generated argon gas plasma was irradiated to the ion-exchanged water, and FIG. 10 shows the graph which similarly shows the relation between the irradiation time of plasma and hydrogen peroxide (H₂O₂) concentration (millimole).

In FIGS. 9 and 10, the result of varying distance δ to 10 mm (open circle), 5 mm (open triangle), 2 mm (open square), and 0 mm (solid circle) −2 mm (solid triangle), respectively is plotted.

From FIGS. 9 and 10, when ion-exchanged water was argon irradiated, it has confirmed that dissolved active oxygen kinds, such as ozone and hydrogen peroxide, were generated in the liquid phase.

The reaction shown in the following formula 1 and formula 2 arises by plasma, and this yields hydroxyl group (OH: hydroxyl radical) and dissolved oxygen (O₂) from the water in the liquid phase, then, the reaction of the following formula 3 and formula 4 arose in the liquid phase and ozone (O₃) and hydrogen peroxide (H₂O₂) were yielded.

(Chemistry 1) H₂O→OH+H (Formula 1)

(Chemistry 2) 2H₂O→O₂+4H (Formula 2)

(Chemistry 3) OH+O₂→O₃+H (Formula 3)

(Chemistry 4) OH+OH→H₂O₂ (Formula 4)

In FIG. 9, the result of varying distance δ shows the nearer the distance from the tip of silica tube 41 to solution, the higher the concentration of ozone and hydrogen peroxide, that is the higher reactivity of argon plasma.

This is considered, for the density of argon plasma to decrease as it separates from the tip of a silica tube. Moreover, lengthening irradiation time of plasma can also make concentration of ozone or hydrogen peroxide high.

By using the result of this embodiment, the dissolved active oxygen kind was generated from the water in the liquid phase by glaring argon plasma, when washing the surface of semiconductor wafer with the ultrapure water (rinse water) supplied on the revolving semiconductor wafer.

### Embodiment 3

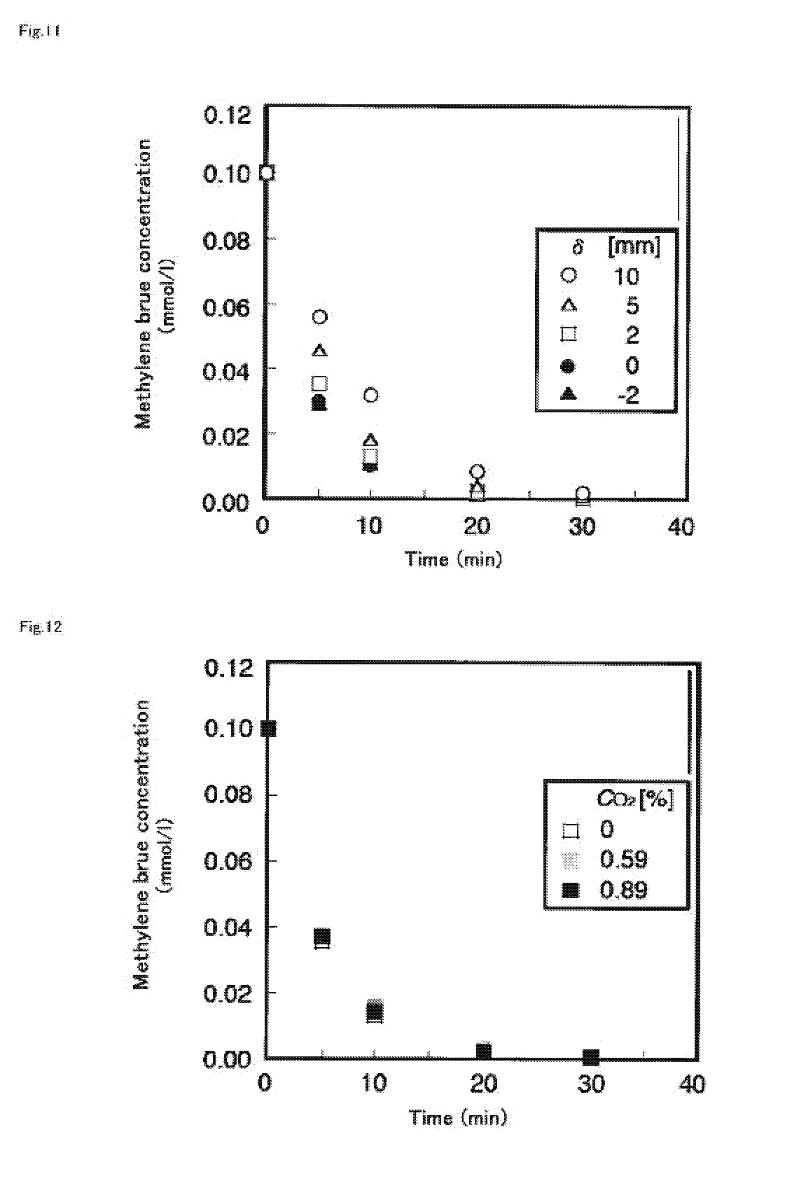

In this embodiment, the plasma device of composition of being shown in FIG. 4 was used, and plasma processing of the methylene blue solution was carried out by the plasma of argon gas simple substance (FIG. 11) or the plasma of argon gas and oxygen gas mixed gas (FIG. 12) generated in normal pressure.

The plasma of the argon gas simple substance generated on the same conditions as the embodiment 2, and the plasma by the mixed gas of argon gas and oxygen gas generated by the rate of the oxygen gas 0, 0.59, and 0.89% in FIG. 8.

The silica tube 41 and glass reaction vessel have been arranged like the embodiment 2, and the solution in which methylene blue dissolved was put in 20 ml of ion-exchanged water in glass reaction vessel so that it might become with 0.1 millimole/l.

The distance δ from the tip of the silica tube 41 to the surface of solution was considered as variable in the range of −2 mm-10 mm when argon gas simple substance was used, and 2 mm for mixed was used. Where distance δ=−2 denotes the state which the tip of the silica tube 41 inserted into solution by 2 mm.

FIG. 11 is the graph which shows the relation between the irradiation time of the plasma and methylene blue concentration (millimole) when irradiating plasma generated with an argon gas simple substance.

In FIG. 11, the result is plotted with varied distance δ by 10 mm (open circle), 5 mm (open triangle), 2 mm (open square), 0 mm (solid circle), and −2 mm (solid triangle).

From FIG. 11 result, the concentration of methylene blue solution becomes low by irradiation of argon plasma, and it has confirmed that methylene blue was decomposed by plasma processing.

When argon plasma contacts the liquid phase, dissolved active oxygen kinds, such as a hydroxyl group, hydrogen peroxide, and ozone, are generated from the water in solution, and it is considered methylene blue has decomposed with this dissolved active oxygen kind, as it was confirmed in the embodiment 2.

Result in FIG. 11 shows the nearer distance δ from tip of the silica tube 41 to solution, the quicker decomposition rate of methylene blue and the higher reactivity of plasma, it fits in the concentration of the dissolved active oxygen kind of FIG. 9 and FIG. 10.

FIG. 12 is the graph which shows the relation between the irradiation time of the plasma and methylene blue concentration (millimole) when irradiating plasma generated with the mixed gas of argon gas and oxygen gas.

Also in FIG. 12, when methylene blue solution was irradiated with mixed gas plasma, the concentration of methylene blue became low and it has confirmed that methylene blue was decomposed by plasma processing.

Although the rate of oxygen gas was changed with 0%, 0.59%, and 0.89%, result was almost the same.

### Comparative Example 1

Although plasma processing of ion-exchanged water and the methylene blue solution was carried out in the embodiment 2 and 3 with the plasma generated in normal pressure with the plasma generation device of this invention shown in FIG. 4, in this comparative example 1, plasma processing of ion-exchanged water and the methylene blue solution was carried out using the plasma jet generated in the portions of the first plasma generation chamber of FIG. 4, and the first plasma generation means for comparison.

The specific configuration of the plasma device of the comparative example 1 is coaxially arranged a pair of copper electrodes circular to a silica tube with an inside diameter of 1.5 mm at intervals of 5 mm. Argon gas was supplied by 2.0 l/min of flux, the copper electrode by the side of the upper stream was grounded, a 16 kV pulse wave frequency of 10 kHz was impressed to the copper electrode by the side of the lower stream, and the plasma jet was generated.

The solution of methylene blue was dissolved in 20 ml of ion-exchanged water was put in the glass reaction vessel which was maintained by the constant temperature bath 298K as well as the embodiment 2, and the plasma jet orifice at the tip of a silica tube has been arranged to meet the surface of the liquid phase to be processed.

The distance δ from the tip of a silica tube to the surface of the liquid phase was 2 mm. That is, the conditions of the 2 mm (open square) plot, the embodiment 2 in FIG. 9 and the embodiment 3 in FIG. 11 were coincided.

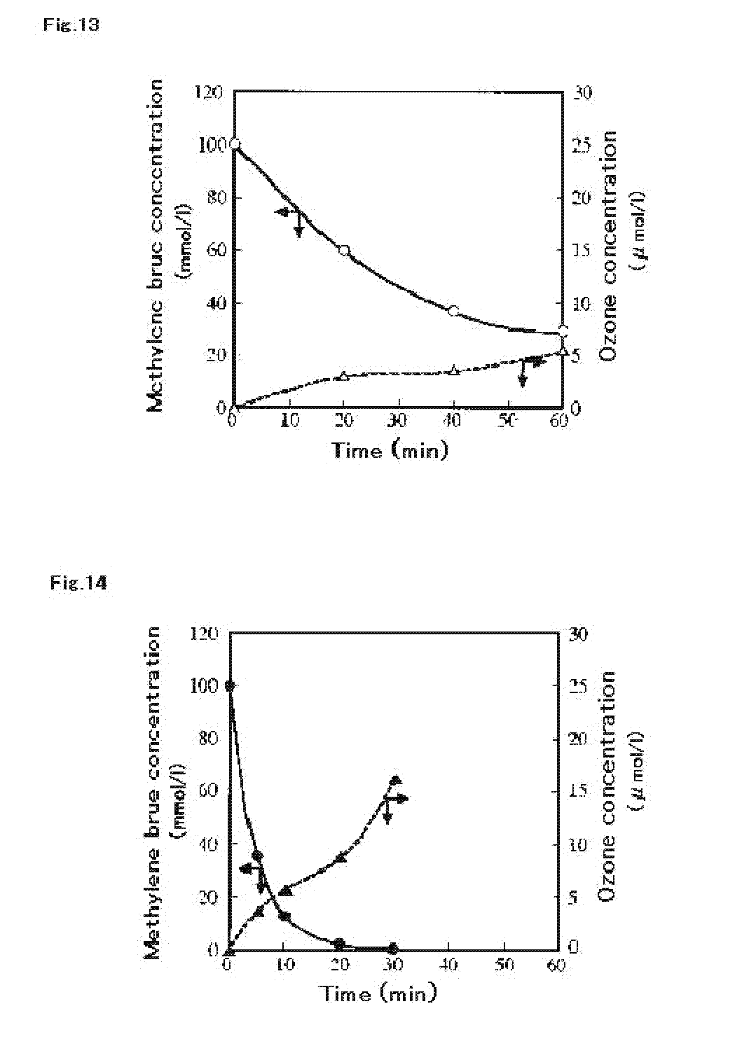

FIG. 13 is the combined graph of relation between the irradiation time of the plasma jet irradiating to ion-exchanged water, and ozone (O₃) concentration (micromol) in the embodiment 2 (open triangle: the right axis of FIG. 13), and graph of relation between the irradiation time of plasma jet irradiating to methylene blue solution and methylene blue concentration (millimole) in the comparative example 1 (it is open circle: the left axis of FIG. 13).

FIG. 14 is the combined graph the 2 mm (open square) plot of FIG. 9 in embodiment 2 and FIG. 11 in embodiment 3 for comparison.

In addition, in FIG. 14, the 2 mm plot of the embodiment 2 is written by a solid circle, and the 2 mm plot of the embodiment 3 is written in the solid triangle.

FIG. 13 and FIG. 14 shows it is clear the plasma generated with the plasma generation device of this invention in normal pressure has high reactivity compared with the plasma jet generated with the plasma generation device of the comparative example 1 in normal pressure.

That is, although ozone is generated only 5 micromol, by irradiating for 60 minutes in the plasma jet generated in normal pressure with the plasma generation device of the comparative example 1 of FIG. 13, in the other hand 16.3 micro mol of ozone is yielded by the irradiation for 30 minutes with the plasma generated in normal pressure with the plasma generation device of this invention of FIG. 14.

Moreover, as for the half-life period comparison of methylene blue, the plasma jet generated in normal pressure with the plasma generation device of the comparative example 1 of FIG. 13 is about 8 times compared with about 4 minutes of the plasma generated in normal pressure with the plasma generation device of this invention of FIG. 14.

### Embodiment 4

The plasma device of composition shown in FIG. 5 was used in this embodiment, and plasma was generated from oxygen gas, nitrogen gas, or air using the second plasma gas (oxygen gas, nitrogen gas, or air) different from first plasma gas.

The specific configuration of plasma device has piping 51 used the silica tube 51 with inside diameter of 1.5 mm, and coaxial a pair of circular copper electrodes 52a and 52b arranged at intervals of L1=5 mm to the upper stream side of the silica tube 41.

Since the length of one copper electrode was 30 mm, the first plasma generation chamber 10 is a 65 mm domain in the silica tube 51 alongside a pair of copper electrodes 52a and 52b.

The surface of a pair of cylindrical electrodes 52a and 52b is covered with the epoxy resin as insulation material 53, and connected the first low frequency AC power supply which is not illustrated.

Furthermore, the silica tube 51 is connected with the silica plasma torch 54 with an inside diameter of 30 mm as the second plasma generation chamber at the lower stream side. The distance from the first plasma generation means (lower end of the copper electrode 52b) to a plasma feed opening (tip of piping 51) was 50 mm-55 mm.

A plasma torch 54 has the gas feed port 54a aslant prepared to the side of a plasma torch 54, and it is constituted the gas supplied in the plasma torch 54 may flow spirally alongside.

The hollow copper coil 55 is formed outside of the plasma torch 54 as second plasma generation means, and not illustrated the second power supply is connected to the coil 55.

Since the distance from a plasma feed opening to coil 55 was about 20 mm, the distance from the first plasma generation means (lower end of the copper electrode 52b) to the second plasma generation means (upper end of coil) was 70-75 mm.

Furthermore, the distance from the second plasma generation means to the tip of a plasma torch was about 20 mm.

Moreover, from the coolant feed port 56a, to the cooling means 56 between coil 55 and a plasma torch 54, air was supplied 30 l/min of flux as coolant, air has injected from the coolant jet orifice 56b to cover plasma.

Furthermore, the first plasma generation chamber 10 and a pair of electrodes 52a and 52b are surrounded with the insulating protection pipe 57 and the insulating board 58 which consist of PEEK material, and also since a crevice is filled up with silicone resin sealing to be insulated from the circumference.

In the plasma device of such composition, although helium (helium) gas is passed to the silica tube 51 by 2 l/min of flux as the first plasma gas, and oxygen gas was introduced into the plasma torch 54 by 15 l/min of flux as the second plasma gas from the gas feed port 54a, and the electric power of 40.68 MHz and 1200 W was supplied from the second power supply which is not illustrated to coil 55, plasma was not able to be generated from oxygen gas in this state.

Then, when a pulse wave (14 kV and 10 kHz) is impressed from the first power supply between a pair of electrodes 52a and 52b, plasma was able to occur at the first plasma generation chamber, and by the plasma from the first plasma generation chamber being supplied, plasma was able to be generated from oxygen gas in the plasma torch 54 which is the second plasma generation chamber.

Then, after the first power supply was shut off, impression of the pulse wave of a between a pair of electrodes was stopped and supply of the helium gas which is the first plasma gas simultaneously was also stopped, the plasma by oxygen gas was maintained.

Furthermore, as a modification of this embodiment, by remaining other conditions as it is, the second plasma gas changed from oxygen gas into nitrogen gas or air (all are 15 l/min of flux) in the plasma torch 54, plasma was able to be generated also from nitrogen gas or air by supplying the plasma from the first plasma generation chamber.

Moreover, instead of helium gas, argon gas was passed by 2 l/min of flux as the first plasma gas, oxygen gas plasma was able to be generated like the helium gas case.

By varying the distance between a pair of electrodes was changed from 5 mm, in 2-7 mm, the plasma jet of helium gas and argon gas was able to be generated in the silica tube 51, and oxygen gas plasma was able to be generated in the plasma torch.

Moreover, since distance between a pair of electrodes was shortened, dropped the voltage of 14 kV to 8 kV, the plasma jet of helium gas and argon gas was able to be generated.

Furthermore, the plasma jet of helium gas and argon gas was able to be generated also as a low frequency wave of not 10 kHz but 50-200 Hz for the frequency of the pulse wave supplied from the first electrode.

For comparison, all the other conditions are the same except a pulse wave was not impressed between a pair of electrodes and not generating plasma at the first plasma generation chamber, though oxygen gas, nitrogen gas, or air was supplied to the plasma torch and electric power was supplied to the coil, plasma was not generated at all.

### Embodiment 5

In this embodiment, plasma was generated using the plasma torch as first plasma generation chamber like the plasma device of configuration shown in FIG. 6.

As first plasma generation chamber, the first silica plasma torch 62 inside diameter of 14 mm and outside diameter of 16 mm is used, and helium gas is supplied by 15 l/min of flux as the first plasma gas.

A cooling means 64 of outer diameter 20 mm is formed in the circumference of the first plasma torch 62, and air supplied by 30 l/min of flux as coolant.

Furthermore, the first plasma torch 62 was able to generate plasma, without using an ignition means, with the coil 63 arranged outside and RF (700 W and 40 MHz) was supplied to the coil 63 from the first power supply.

By supplying the plasma generated in the first plasma torch 62 to connected plasma torch 54 of the embodiment 4 as the second plasma torch 65, plasma was able to be generated in the plasma torch 54 from oxygen gas, nitrogen gas, or air as the embodiment 4.

### Embodiment 6

In this embodiment, plasma was generated using the plasma processing device of configuration shown in FIG. 15.

Piping 41 used the silica tube 41 with an inside diameter of 1.5 mm, and the specific composition of plasma processing device has coaxial a pair of circular copper electrodes 42a and 42b at intervals of L1=5 mm arranged to the upper stream side of the silica tube 41.

Since the length of one copper electrode was 10 mm, the first plasma generation chamber 10 is a 25 mm domain in the silica tube 41 alongside a pair of copper electrodes 42a and 42b.

And the hollow copper coil 45 (3 turns: length alongside silica tube 15 mm) of 3 mm outsides has been arranged around the silica tube 41 to the lower stream side of the first plasma generation chamber 10.

The distance L2 from the first plasma generation chamber 10 to the second plasma generation chamber 20 was 50 mm. Moreover, the distance L3 from the lower end of the copper coil 45 to the tip of the silica tube 41 was 15 mm.

In addition, the cooling water circulating the hollow of the copper coil 45 to cool the second plasma generation chamber.

Furthermore, the grounded bias electrode 150 is arranged at the lower stream side.

The distance L4 from the lower end of the second plasma generation chamber 20 to the bias electrode 150 was 7 mm. In addition, the length of the bias electrode 150 was 5 mm, and the distance from the lower end of the bias electrode 150 to the tip of the silica tube 41 was 3 mm.

In this plasma processing device, argon (Ar) gas is supplied by 2.0 l/min as plasma gas from the upper stream of piping 41, voltage is impressed to a pair of copper electrodes 42a and 42b, and the copper coil 45 then plasma can be generated at the second plasma generation chamber 20 without using an ignition means on following condition.

As for a pair of copper electrodes 42a and 42b, the copper electrode 42a by the side of the upper stream was grounded, and the 10 kHz AC pulse wave of ±16 kV was impressed to the copper electrode 42b by the side of the lower stream about 1 second duration at the ignition time by the second plasma generation means.

Moreover, electric power of 100 W, 144.2 MHz RF was supplied to the copper coil 45 as the second plasma generation means.

The bias electrode 150 was always grounded.

Length ξ from the lower end of the copper coil 45 to the tip of plasma of the second plasma generated at the second plasma generation chamber 20 was 65 mm.

On the same conditions, when the bias electrode 150 was not formed, the plasma generated at the second plasma generation chamber 20 was prolonged on both sides of the upper stream and the lower stream, and length ξ from the lower end of the copper coil 45 to the tip of plasma was 35 mm.

Thus, the second plasma generated at the second plasma generation chamber was able to be expanded to the lower stream side with the bias electrode 150.

### Embodiment 7

In this embodiment, plasma was generated using the plasma processing device of composition as shown in FIG. 16.

Piping 41 used the silica tube 41 with an inside diameter of 1.5 mm, and the specific composition of plasma processing device has arranged the hollow copper coil 45 (3 turns: length alongside silica tube 15 mm) of 3 mm diameter around outside the silica tube 41 as second plasma generation means to the upper stream side of the silica tube 41.

Moreover, the distance L3 from the lower end of the copper coil 45 to the tip of the silica tube 41 was 15 mm. In addition, cooling water is circulating in the hollow copper coil 45 to cool the second plasma generation chamber.

Furthermore, the circular copper electrode 160 and the first power supply 161 have been arranged to the lower stream side of the copper coil 45.

The distance L5 from the lower end of the copper coil 45 to the upper end of the copper electrode 160 was 7 mm, and the distance from the lower end of the copper electrode 160 to the tip of the silica tube 41 was 3 mm.

In this plasma processing device, argon (Ar) gas is supplied by 2.0 l/min as plasma gas from the upper stream of piping 41, then the second plasma generation chamber 20 was able to generate the second plasma without using an ignition means when electric power is impressed to the copper electrode 160 and the copper coil 45 on following condition.

The pulse wave of ±16 kV, 10 kHz AC was impressed to the copper electrode 160 about 1 second duration at the ignition time which generates plasma by the second plasma generation means.

The first plasma 162 elongated to the upper stream and lower stream side occurred in the first plasma generation chamber 10 by this pulse wave.

The electric power of 100 W, 144.2 MHz RF was supplied to the copper coil 45 which is the second plasma generation means.

Length ξ from the lower end of the copper coil 45 to the tip of plasma of the second plasma generated at the second plasma generation chamber 20 was 63 mm.

### Embodiment 8

In this embodiment, although the liquid phase content means 172 was not used, plasma was generated using the plasma processing device of configuration shown in FIG. 17.

Piping 41 and piping 171 are 1.5 mm in inside diameter, and the specific composition of plasma processing device has arranged a pair of circular coaxial copper electrodes 42a and 42b at intervals of L1=5 mm for piping 171.

In addition, since the length of one copper electrode was 10 mm, the first plasma generation chamber 10 is a 25 mm domain in the piping 171 alongside a pair of copper electrodes 42a and 42b. Piping 171 had connected with piping 41 in the position of 5 mm lower stream side from the first plasma generation chamber 10, and the hollow copper coil 45 (3 turns: length alongside piping 15 mm) of 3 mm of outside diameter is arranged at the position 10 mm from the connecting position to the lower stream side.

That is, since the distance from the upper end of the second plasma generation chamber 20 to a connecting part was 10 mm, and the distance from connecting part to the first plasma generation chamber 10 was 5 mm, the distance of the first plasma generation chamber 10 to the second plasma generation chamber 20 was 15 mm.

The angle θ between piping 41 and piping 171 was about 60 degrees.

Moreover, the distance L3 from the lower end of the copper coil 45 to the tip of piping 41 was 15 mm.

In addition, cooling water circulates through in the hollow part of the copper coil 45 to cool the second plasma generation chamber.

In this plasma processing device, argon (Ar) gas was supplied by 1.0 l/min as plasma gas from the upper stream of piping 41, and argon (Ar) gas was supplied by 1.0 l/min as plasma gas also from the upper stream of piping 171.

As for a pair of copper electrodes 42a and 42b, the copper electrode 42a by the side of the upper stream was grounded, and the AC pulse wave of 10 kHz voltage of ±16 kV was impressed to the copper electrode 42b by the side of the lower stream about 1 second duration at the ignition which generates plasma by the second plasma generation means.

Moreover, the RF electric power of 100 W, 144.2 MHz was supplied to the copper coil 45 which is the second plasma generation means.

Length δ from the lower end of the copper coil 45 to the tip of plasma of the second plasma generated at the second plasma generation chamber 20 was about 63 mm.

The plasma device of this invention is using the first plasma generated from the first plasma gas at the first plasma processing chamber as an ignition means, it enables to generate the second plasma even in the condition where plasma did not generate without an ignition means.

### EXPLANATION OF MARK

10 The first plasma generation chamber
11 The first plasma generation means
12 Gas feed opening
13 Plasma exit
14 Electric power provider
15 The first power supply
20 The second plasma generation chamber
21 The second plasma generation means
22 Plasma feed opening
24 Electric power provider
25 The second power supply

1. A plasma generation device comprising a first plasma generation chamber which has a gas feed opening and a plasma exit, and a first plasma generation means arranged in a state without exposure to the space within said first plasma generation chamber, and a second plasma generation chamber which has a plasma feed opening and wherein plasma generated at said first plasma generation chamber is supplied through said plasma exit and said plasma feed opening and wherein a second plasma generation means which is arranged in a state without exposure to the space within said second plasma generation chamber.

2. The plasma generation device of claim 1 wherein said first plasma generation means comprises a pair of electrodes, and established insulating means which prevents electric discharge between said pair of electrodes outside said first plasma generation chamber.

3. The plasma generation device of claim 2 wherein the distance between said pair of electrodes is 2 mm-10 mm.

4. The plasma generation means of claim 1 wherein said first plasma generation means generates plasma by impressing high voltage AC to a single electrode.

5. The plasma generation device of claim 1 wherein bias electrode is arranged at lower stream side of said second plasma generation chamber.

6. The plasma generation device of claim 1 wherein said first plasma generation chamber is arranged at lower stream side of said second plasma generation chamber.

7. The plasma generation device of claim 1 wherein the distance from said first plasma generation means to said second plasma generation means is longer than the length of prolonged plasma which is generated at said second plasma generation chamber from said second plasma generation means.

8. The plasma generation device of claim 1 wherein said first plasma generation chamber is established as part of piping and said second plasma generation chamber is a plasma torch connected with said piping.

9. The plasma generation device of claim 8 wherein the distance from said second plasma generation means to the tip of said plasma torch is 5 mm-15 mm.

10. The plasma generation device of claim 1 wherein said first plasma generating chamber is established as part of a continuous straight piping, and said second plasma generation chamber is established as the other part.

11. The plasma generation device of claim 10 wherein the distance from said second plasma generation means to the tip of said piping is 5 mm-15 mm.

12. The plasma generation device of claim 1 wherein said second plasma generation means comprises coil and generates inductively coupled plasma in said second plasma generation chamber.

13. The plasma generation device of claim 1 wherein plasma is generated in said first plasma generation chamber by said first plasma generation means under state of normal pressure, higher than normal pressure or rough vacuum of 1.333×10⁴ Pa-1.013×10⁵ Pa, then plasma is generated in said second plasma generation chamber using said second plasma generation means and plasma generated in said first plasma generation chamber.

14. The plasma generation device of claim 1 wherein said second plasma generation chamber comprises a gas feed port which enables the introduction of gas without intervention of said first plasma generation chamber.

15. The plasma generation device of claim 1 wherein a liquid phase is established at the lower stream side of said second plasma generation chamber.

16. Plasma generation means wherein a first plasma is generated in a first plasma generating chamber by supplying a first plasma gas and by supplying electric power from a first plasma generation means which is located in said first plasma generation chamber without exposing, and a second plasma is generated in a second plasma generating chamber by supplying a second plasma gas and by supplying electric power from a second plasma generation means which is located in said second plasma generation chamber without exposing, additionally by supplying first plasma generated in said first plasma generation chamber.

17. The plasma generation means of claim 16 wherein said second plasma has a higher density than said first plasma.

18. The plasma generation means of claim 16 wherein said second plasma does not generate plasma until said first plasma is supplied.

19. The plasma generation means of claim 16 wherein the supply of said first plasma gas or power supply of said first plasma generation means is stopped after starting plasma generation in said second plasma generation chamber.

20. The plasma generation means of claim 16 wherein said second plasma generation means supplies electric power to said second plasma generation chamber before said first plasma generation means supplies electric power to said first plasma generation chamber, then said first plasma generated at said first plasma generation chamber by supplying electric power by said first plasma generation means is supplied to said second plasma generation chamber.

21. The plasma generation means of claim 16 wherein said first plasma is supplied to said second plasma generation chamber from the lower stream side.

22. The plasma generation means of claim 16 wherein said first plasma or said second plasma is expanded toward the lower stream side by a bias electrode prepared in the lower side of said second plasma generation chamber.

23. The plasma generation means of claim 16 wherein said first plasma gas is a rare gas such as helium gas, argon gas, xenon gas, or neon gas, and said second plasma gas is one sort of or plurality of rare gas such as helium gas, argon gas, xenon gas or neon gas, a halogenated carbon, a semiconductor gas, pure air, dry air, oxygen, nitrogen, hydrogen, steam, halogen, ozone or SF₆.

24. The plasma generation means of claim 16 wherein part of said first plasma gas is used as said second plasma gas.

25. The plasma generation means of claim 16 wherein said second plasma gas is introduces into said second plasma generation chamber without intervention of said first plasma generation chamber.

26. The plasma generation means of claim 16 wherein said second plasma generation means comprises coil and generates inductively coupled plasma of said second plasma gas.

27. The plasma generation means of claim 16 wherein said first plasma and said second plasma is generated under state of normal pressure, higher than normal pressure or rough vacuum of 1.333×10⁴ Pa-1.013×10⁵ Pa.

28. The plasma generation means of claim 16 wherein said second plasma is emitted into a liquid phase.

29. The plasma generation means of claim 23 wherein said halogenated carbon is a chlorofluorocarbon, a hydrofluorocarbon, or a perfluorocarbon.

30. The plasma generation means of claim 29 wherein said halogenated carbon is CF₄ or C₂F₆.

31. The plasma generation means of claim 23 wherein said semiconductor gas is SiH₄, B₂H₆ or PH₃.
